(19) United States
(12) Patent Application Publication
(10) Pub. No.: US 2024/0429619 A1
(43) Pub. Date: Dec. 26, 2024

(54) BROADBAND PHASED ARRAY WITH INTRA-ELEMENT MONOLITHS

(71) Applicant: Jacobs Technology Inc., Severn, MD (US)

(72) Inventors: Victor C. SANCHEZ, Ellicott City, MD (US); Robert MUMPER-HAM, Severn, MD (US); Todd LEBO, Severn, MD (US); Ryan Lehnerd ETKINS, Worcester, MA (US); Matthew M. WOODARD, Gaithersburg, MD (US)

(21) Appl. No.: 18/752,546

(22) Filed: Jun. 24, 2024

Related U.S. Application Data
(60) Provisional application No. 63/509,592, filed on Jun. 22, 2023.

(51) Int. Cl. H01Q 21/00; H01Q 5/335; H01Q 21/24

(52) U.S. Cl. CPC H01Q 21/0012; H01Q 5/335; H01Q 21/24

(57) ABSTRACT

An intra-element monolith has a plurality of impedance matching elements extending from a base. Shorting posts can be provided to couple the base to an inner portion of the respective impedance matching elements, each having a tapered section extending from a leg section spaced laterally from the base. Capacitive coupling structures can also be provided. The impedance matching elements are configured to define radiator, receiver or transmitter sites between similar, opposing impedance matching elements on adjacent instances of the monolithic element. The leg sections extending from a first adjacent pair of the impedance matching elements can be configured for coupling to a signal connector, and operable to be actively driven. The leg sections extending from a second adjacent pair of the impedance matching elements can be configured for coupling to ground, and operable to be excited by the opposing impedance matching elements.

### CROSS-REFERENCE TO RELATED APPLICATION

This application claims priority to U.S. Provisional Patent Application No. 63/509,592, “Broadband Phased Array with Intra-Element Monoliths,” filed Jun. 22, 2023, which is incorporated by reference herein, in the entirety and for all purposes, including the appendix thereof.

### FIELD

The application relates to broadband phased array antenna structures. More generally, the application concerns radiofrequency (RF) radiating elements formed of intra-element structures or “monoliths” configured to provide a range of broadband transmission and receiving capabilities; e.g., with flared antenna or similar broadband radiators, capacitive coupling between adjacent elements, and balanced feed.

### BACKGROUND

Demand for high-performance active electronically scanned arrays (AESAs) continues to increase as component costs drop and new technologies enable their introduction into new markets. Commercial satellite communications, 5G, internet of things (IoT) as well maritime, airborne and automotive applications increasingly require lightweight, low-cost, broadband electronically scanned antenna solutions.

Early broadband phased array antennas consisted of variants of the Vivaldi tapered slot. These had the advantage of being lightweight and easily fabricated using low cost printed circuit board techniques. Limitations of these antennas included their relatively thick physical profile as well as difficulties in mechanical robustness of the “egg-crate” structures required to achieve dual polarization. Mechanisms to achieve robust dual-polarization solutions were developed but did not suitably reduce the thickness of the elements, which is driven by the underlying physics of a necessarily gradual impedance transform.

Another path to realization of a broadband phased array used high mutual coupling to neighboring elements to create broadband structures while maintaining a physically and electrically low profile. These elements proved difficult to feed, but elegant and complex feed variations based on the Marchand balun were developed. The development of radio-frequency GHz range planar ultra-wideband modular arrays and a new class of planar ultra-wideband modular antenna arrays with improved bandwidth provided an integrated balanced feed mechanism, but its utility and producibility is still hindered by substrate weight and practical limitations for connectorization. Despite these advances, the need remains for broadband phased array structures with intra-element construction that improves manufacturability while matching or improving upon the size, weight and RF performance metrics achieved by prior phased array antenna implementations.

### SUMMARY

A new realization of a broadband phased array is introduced. The array includes a number of individual radiating elements formed of intra-element structures; e.g., metallic, monolithic structures which can be additively manufactured. The radiating elements can be excited through connections on a printed circuit feeder board or other substrate; e.g., using coaxial cables, waveguides, or shielded broadband conductors.

The intra-element structures may be referred to as “monoliths,” and can be assembled to form a phased array of Vivaldi-like flares, Vivaldi antennas, Vivaldi aerials, tapered slot antennas or other broadband radiators suitable for transmitting and receiving electromagnetic radiation, for example radio frequency (RF), microwave, millimeter wave or infrared (IR) radiation, for example in a linearly polarized, circularly polarized, or generalized dual-orthogonally polarized form.

Additional features can include, but are not limited to, tight capacitive coupling to neighboring elements, built-in shorting posts or similar connections configured to provide a balanced (or unbalanced) feed. Additional performance-enhancing RF features are also contemplated, for example height-variable capacitance and mechanical features configured to improve construction, providing a lightweight, reliable, and repeatable (consistent) physical format, suitable for automated pick-and-place fabrication on a printed circuit board or other substrate.

### BRIEF DESCRIPTION OF THE DRAWINGS

FIG. 1 is a side elevation view of a phased broadband array.

FIG. 2 is a top-down plan view of a broadband array.

FIG. 3 is an isometric view of an intra-element monolith for a broadband array.

FIG. 4A is a top perspective view of a radiator feed and translation board for a broadband array, with a single intra-element monolith.

FIG. 4B is a bottom perspective view of the radiator feed and translation board.

FIG. 5A is an isometric view illustrating a unit cell definition for an intra-element monolith disposed on a circuit board.

FIG. 5B is a detail view of a dielectric spacer or cap on the intra-element monolith.

FIG. 5C is a bottom perspective view of the radiator feed and translation board with emphasis on the circuit board detail.

FIG. 6A is a side elevation view of adjacent intra-element monoliths for a broadband array6.

FIG. 6B is a top isometric view of the adjacent intra-elements monoliths.

FIG. 7 is plot of simulated return loss and cross polarization coupling for a broadband array.

FIG. 8 is Smith Chart for the complex simulated reflection coefficient of a broadband array.

FIG. 9A is a line drawing of a broadband array with a three-by-three intra-element monolith configuration, in perspective-side view.

FIG. 9B is an alternate line drawing of the broadband array, in perspective-plan view.

FIG. 10 is a plan view of a three-by-three section of a circuit board for a broadband radiator array.

FIG. 11 is plot of measured and simulated S-parameters for a set of ports in the three-by-three broadband array.

FIG. 12 is an isometric view of an alternate form of the intra-element monolith.

FIG. 13 is a side elevation view of the intra-element monolith in FIG. 12, mounted on a feeder board.

FIG. 14A is a detail section view of a first foot connection to a circuit board; e.g., according to FIGS. 12 and 13.

FIG. 14B is a detail section view of a first base connection to the circuit board.

FIG. 14C is a detail section view of a second base connection to the circuit board.

FIG. 14D is a detail section view of a second foot connection to the circuit board.

FIG. 15 is a bottom plan view of the circuit board, illustrating an offset base connection.

FIG. 16A is a bottom plan view of an intra-element monolith; e.g., according to FIGS. 12 and 13.

FIG. 16B is an isometric view of the intra-element monolith, illustrating the base structure.

FIG. 17A is a side elevation view showing a set of intra-element monoliths; e.g., according to FIGS. 12, coupled to a circuit board according to FIG. 13.

FIG. 17B is a perspective view showing a two-by-two array of intra-element monoliths coupled to the circuit board, forming a section of a broadband array.

FIG. 18 is a plot of simulated return loss and cross polarization coupling for a broadband array formed of intra-element monoliths; e.g., according to FIGS. 17A and 17B.

FIG. 19 is Smith Chart for the complex simulated reflection coefficient of the broadband array.

FIG. 20 is a perspective view of a broadband array formed of intra-element monoliths coupled to a circuit board.

### DETAILED DESCRIPTION

This disclosure is directed to an Intra-element Monoliths Printed And attached to a CircuiT board (“IMPACT”) system. The system provides a radiator, receiver or transmitter structure that takes advantage of features of the Vivaldi taper for high frequency performance, the connected array for lower frequency performance, and shorting posts for simplicity in the feed.

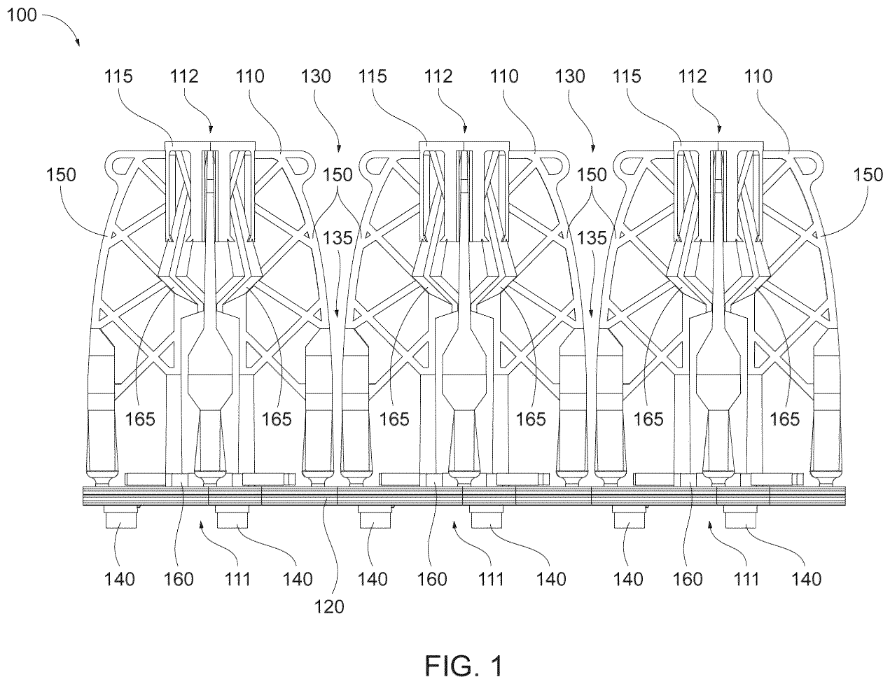

FIG. 1 illustrates a side elevation view of a phased broadband array 100. The array 100 includes a number of periodically spaced metallic monoliths 110, mounted on, atop or adjacent a suitable substrate such as a feeder board or printed circuit board 120.

Each monolith 110 can be formed of a contiguous piece of metal material, which serves as an intra-element structure of the array 100. Gap regions (or gaps) 130 are defined between adjacent monoliths 110. Radiating, receiving, or transmitting sites (generically, “radiators”) 135 are defined in the gap regions 130, between opposing tapered, impedance matching (tapered slot edge) elements 150.

Individual monoliths 110 extend from the lower or bottom portion 111, disposed on or adjacent the feeder board or circuit board 120, to an upper or top portion 112, opposite bottom portion 111. Gap regions 130 are defined between neighboring monoliths 110, forming radiating sites 135. Signal connectors 140 can be provided on circuit board 120 for coupling to monoliths 110, for example in the form of coaxial cable connectors, or other wideband signal interfaces.

Radiating sites 135 are defined between opposing pairs of impedance matching elements 150, extending from the adjacent intra-element monoliths 110. Radiating sites 135 can also be configured to transmit or receive radiation, or to both transmit and receive radiation; e.g., in a radiator, receiver or transmitter configuration for array 100 of monoliths 110, with circuit board 120, signal connectors 140 adapted accordingly. Sites 135 can also be configured as radiators, receivers, transmitters or transceivers, and referred to generically as “radiators” or “radiating sites” 135.

Ground plane connections can be provided via the base 160 of monolith 110, for example in the form of a generally circular, square, rectangular or oblong base frame or mount structure 161, on the bottom portion 111 of each monolith 110. Capacitive coupling may be provided by planar “wall” features forming capacitive coupling structures 165, extending between the adjacent impedance matching elements 150.

As shown in FIG. 1, for example, tapered slot edge type impedance matching elements 150 on adjacent monoliths 110 define the radiating sites (or receiver/transmitter sites) 135 with a tapered slot impedance matching geometry, or with a similar tapered or Vivaldi geometry, extending from the lower region of the gap 130 (e.g., toward the bottom portion 111 of monolith 110, on or adjacent the circuit board 120), toward the upper region of the gap 130 (e.g., toward to top portion 112 of the adjacent monoliths 110). Depending on application, opposing impedance matching elements 150 may also be defined with a corresponding limb, branch, wing or “ear” geometry, as further described herein.

A dielectric cap or spacer 115 can be disposed at the top portion 112 of each intra-element monolith 110; e.g., formed of a plastic, polymer, composite or other dielectric or non-metallic material. The composition and geometry of the top spacer 115 can be selected to provide an electrically insulating, dielectric, structurally stable coupling between adjacent impedance matching elements 150, for example along the planar or wall-shaped capacitive coupling elements or structures 165, providing capacitive coupling between the tapered edge structures of adjacent impedance matching element 150.

Three functions are thus built-into each monolith 110. A Vivaldi function is provided by the taper, flare or fluted edge structure of each impedance matching element 150, defining the radiating sites (or receiver/transmitter sites) 135 in the gaps 130 between neighboring monoliths 110. Capacitive edge-coupling is provided by the proximate geometry of the metallic capacitive coupling structures 165, in the center-top of each monolith 110. The base 160 at the center of bottom portion 111 of each monolith 110 provides an RF path to ground for the asymmetric mode shorting (i.e., balun) function, e.g., while additionally providing a mechanical base frame or mount structure 161 configured for mounting monoliths 110 to circuit board 120.

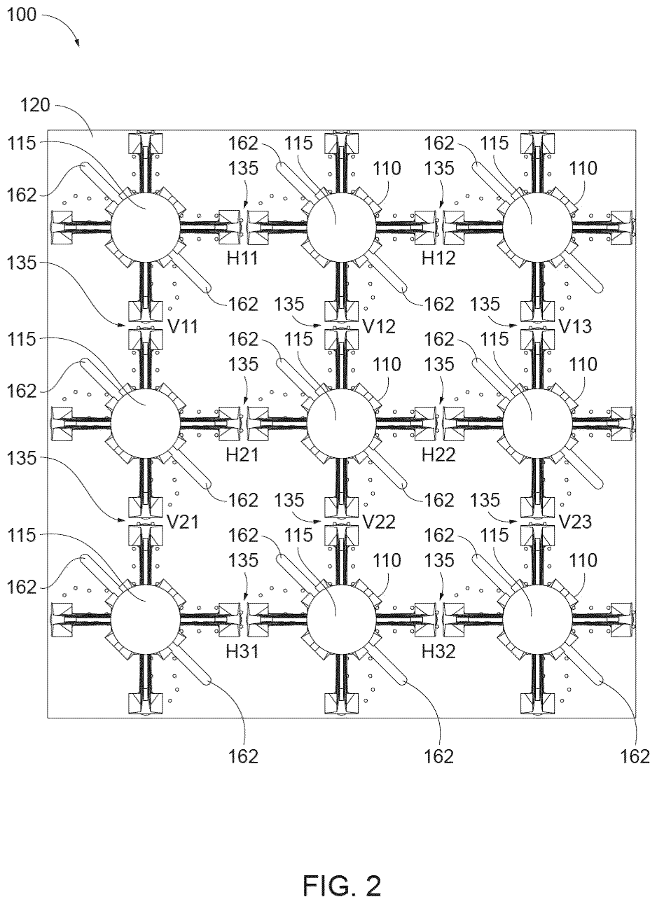

FIG. 2 illustrates a top-down plan view of a phased broadband array 100 formed by a number of intra-element monoliths 110 disposed on a suitable substrate such as a feeder board or circuit board 120; e.g., according to FIG. 1. Spacers 115 can be provided for each monolith 110, or spacers 115 may be absent from one or more monoliths 110. Impedance matching elements 150 (e.g., in the form of tapered slot edge structures as shown) define the radiating sites 135 between adjacent intra-element monoliths 110. One or more alignment bars 162 can be provided at the base of each monolithic element 110; e.g., with one or more alignment pins on the ends of each alignment bar 162, facing down into the circuit board 120 to help position the respective monoliths 110, and to improve adjacent monolith-to-monolith spacing and rotational alignment.

Labels or indices Hij identify the phase centers for a first set of polarized radiating sites 135 (e.g., with horizontal orientation and polarization), and labels or indices Vij identify the phase centers for a complementary set of transversely or orthogonally oriented (e.g., with vertical orientation and polarization) sites 135. In the particular example of FIG. 2, for example, array 100 has a three-by-three (3×3) configuration of monoliths 110, forming a 3×2 array of horizontally polarized (H-pol) sites 135 with indices Hij, and a 2×3 array of vertically polarized (V-pol) sites 135 with indices Vij.

More broadly, the number of monoliths 110 varies based on application, along with the corresponding number of radiating sites 135. The orientation and polarization of the phase centers Hij (H-pol) and Vij (V-pol) also varies. The transverse or orthogonal (horizontal and vertical) orientations and polarizations may also be considered arbitrary, depending on the orientation of array 100 on circuit board 120, and these designations may be reversed or exchanged without loss of generality.

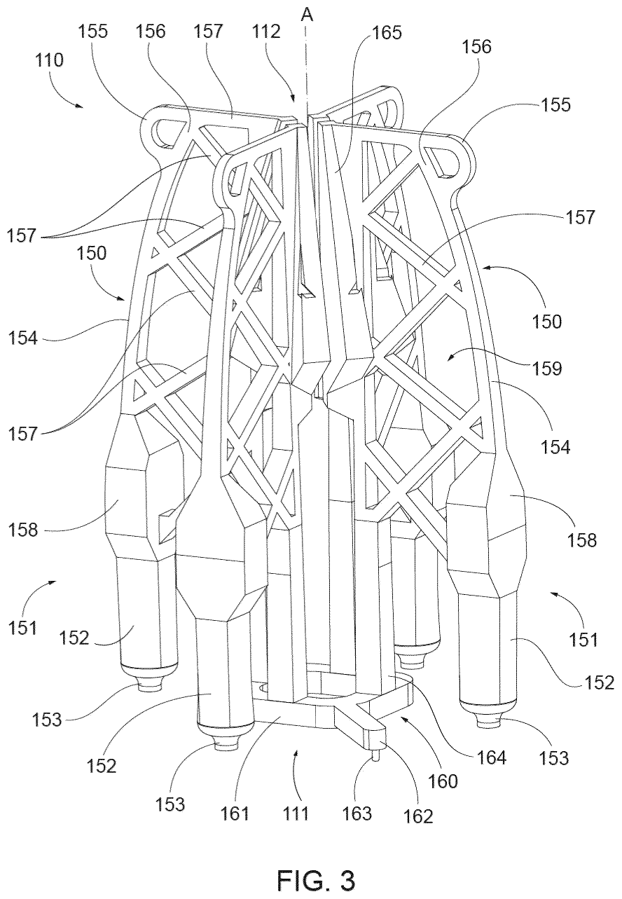

FIG. 3 is an isometric view of an intra-element monolith 110; e.g., for use in a broadband array 100 as shown in FIG. 1 or FIG. 2. Monoliths 110 can be formed from or as a contiguous piece of metal or other suitable material (e.g., a conductor), which functions as an intra-element section of a broadband array 100.

Monoliths 110 can be formed with any suitable number of impedance matching elements 150; e.g., with four transversely oriented, generally symmetric, tapered slot edge impedance matching elements 150 disposed about a central axis A. In the particular example of FIG. 3, each impedance matching element 150 extends upward from a base 160 at the bottom portion 111 of the respective monolith 110, to or toward the top portion (or top) 112. Base 160 can be formed with a base frame or mount structure 161 coupled to shorting posts 164, and provided with one or more alignment bars 162. For example, each alignment bar 162 may extend outward from the mount 161, with one or more vertically oriented locating pins or alignment pins 163.

As further illustrated in FIG. 3, impedance matching elements 150 can define a tapered structure extending radially outward from central axis A to tapered section 154, at the radially outer edge of each element 150. Tapered section 154 extends vertically from a lower “leg” section 151 defining a “foot” 152 on the bottom (lower portion) 111 of monolith 110, through the upper flared section 156 in the top (upper) portion 112, opposite the bottom portion 111. The leg section 151 can include one or more capacitive or reinforcing structures 158 between the foot section 152 and tapered section 154; e.g., to provide capacitance for the RF signal, or a physical reinforcement at the transition between leg section 151 and tapered section 154 of the impedance matching element 150, or both. The structures 158 can be configured to provide both capacitance and physical reinforcement for the respective impedance matching elements 150.

In the example of FIG. 3, adjacent impedance matching elements 150 are transversely or orthogonally oriented, with opposing impedance matching elements 150 disposed in a substantially parallel or planar configuration. Depending on application, monoliths 110 may also include one, two, three, four or more impedance matching elements 150, in transverse, orthogonal, parallel, or skew relationships. Individual impedance matching elements 150 may define a tapered edge or Vivaldi-type structure as shown, or be defined with discretely stepped, limb, branch, wing or “ear” shaped geometries, or other impedance matching structures suitable for use in a wide-band array.

One or more connectors 153 can be provided to couple the foot section 152 of the respective impedance matching element 150 to a signal or grounded connector; e.g. on a circuit board or feeder board connected to monolith 110 at the bottom portion 111. For example, connectors 153 can be formed as surface mount connectors or through-hole type pin connectors, or extend to any selected depth between the top and bottom surface of the circuit board to which monolith 110 is mounted. One or more impedance tuning features 155 can also be provided, for example along the flared section 156 oriented toward the top portion 112 of monolith 110, as shown in FIG. 3, or in the middle (tapered) section 154, or in some examples on one or more of the leg sections 151 or fect 152.

A network of truss, strut or web structures 157 can be extended between the tapered and flared (or “fluted”) sections 154, 156 of impedance matching elements 150, which define the radially outer edge portion of the tapered edge structure, to an inner column or banyan root or similar vertical shorting post structure 164 at the radially inner portion. For example, the shorting posts 164 can connect to the (grounded) central base 160 defined at the bottom portion 111 of monolith 110; e.g., extending upward from base frame or mount structure 161 along the central axis A to or toward the top portion 112 of monolith 110, as shown in FIG. 3.

Spaces, apertures or openings (voids) 159 can be defined between the adjacent truss or web structures 157, reducing the mass of monolith 110, while the structures 157 maintain strength and dimensional tolerance. Alternatively, truss, strut, web, rib, bar or lattice-type structures 157 can be used, or impedance matching elements 150 may be formed as substantially continuous planar structures, extending continuously between the outer tapered and flared sections 154, 156, to the shorting post 164 coupled to the central frame or mount structure 161 of base 160.

One or more capacitive or reinforcing structures 158 can also be provided on impedance matching elements 150; e.g., on the leg section 151, between the foot 152 and tapered section 154. Capacitive coupling structures (or “couplers”) 165 can be provided along or adjacent the radially inner shorting post 164 or coupled thereto; e.g. in the form of opposing planar, metallic capacitive coupling structures 165 oriented at a skew angle; e.g., about 45° (45 degrees) between adjacent impedance matching elements 150, toward the top end of monolith 110. In other examples, the location and geometry of structures 158 and capacitive coupling structures 165 may vary, depending on application.

### Intra-Element Monolith Features

The instantiation of a broadband array 100 according to FIGS. 1 and 2 can make use of additively manufactured monoliths 110 according to FIG. 3. This allows freedom to implement several additional features that improve RF performance and address practical tolerance and fabrication concerns. One such feature is the ability to change the amount of edge-to-edge capacitive coupling in the center region of the monolith 110 as a function of height above the ground plane; e.g., via adapting the geometry of the capacitive coupling structures 165 (e.g., in the form or vertical, planar “wall” structures) disposed between adjacent impedance matching elements 150. Doing so is found to improve operational bandwidth for a given physical gap width (e.g., allowing for increases in the center gap dimension, which in turn relaxes manufacturing tolerances).

Another feature is the ability to widen the “neck” of the tapered section 154 near the base of the radiator feed, proximate the leg section 151 or foot 152, and/or in the region of the capacitive/reinforcing structure 158. This enables use of a larger gap between neighboring monoliths 110 while maintaining the necessary Vivaldi slot impedance taper (while again relaxing mechanical tolerance requirements). This combination of features has an ancillary benefit in allowing for more flexibility in how the outside perimeter edges of the array are constructed; e.g., to allow for tiling of subarrays into a larger main array.

Because the tolerances mentioned above are also important to maintaining performance, additional features can be included to help control these tolerances in a matter that is benign to the radio frequency (RF) energy. The first of these are the dielectric spacer elements 115 (shown in FIGS. 1 and 2) that can be placed at the top center of each monolith 110. The spacers 115 help to more tightly control the intra-element capacitance, e.g., by maintaining dimensional stability of the spacing between adjacent capacitive coupling structures 165. Spacers 115 may also provide features for coupling to the monoliths 110, for maintaining capacitive spacing, and for grabbing the monolith 110 for placement on the substrate, such as a feeder board or circuit board 120, for example using a pick-and-place system as described herein.

Additionally, alignment bars 162 can be coupled to the frame or mount structure 161, as defined by the base 160 of each monolithic element 110. Alignment bars 162 protrude out into the inter-cardinal region of the grid (FIG. 2), between adjacent monolithic elements 110. The alignment bars 162 can be provided with locating/alignment pins 163 on the ends, facing down into the circuit board 120, to help ensure consistent monolith-to-monolith spacing and rotational alignment of the monoliths 110.

To further improve mechanical performance, the solid wall construction typically associated with Vivaldi flares can replaced with lightened truss or web structures 157 interspaced with spaces or apertures 159 to reduce mass. This combination of features reduces overall weight of the monolith 110, and improves performance under a wide range of mechanical and operational stresses including shock, vibration, deformation of the circuit board 120, and temperature changes.

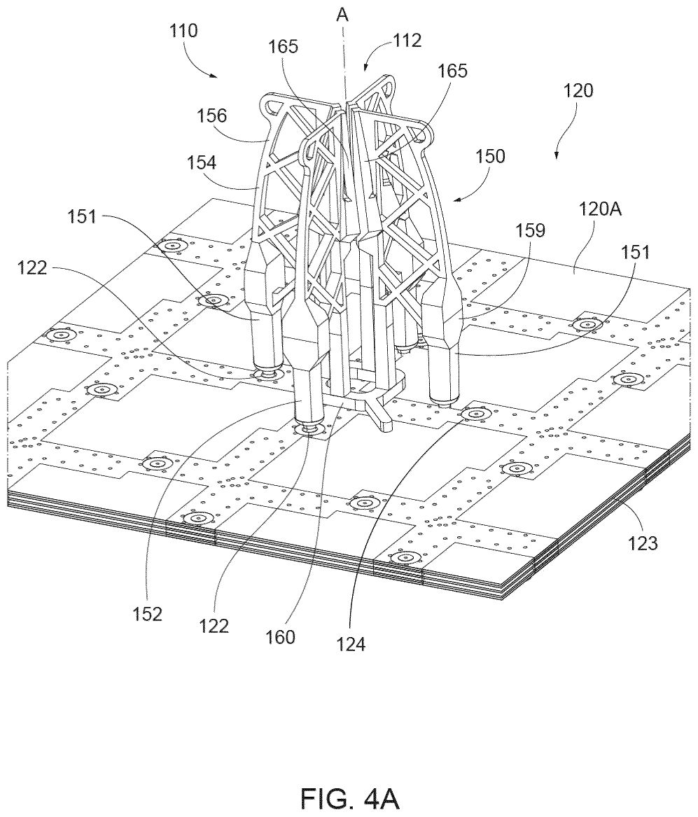

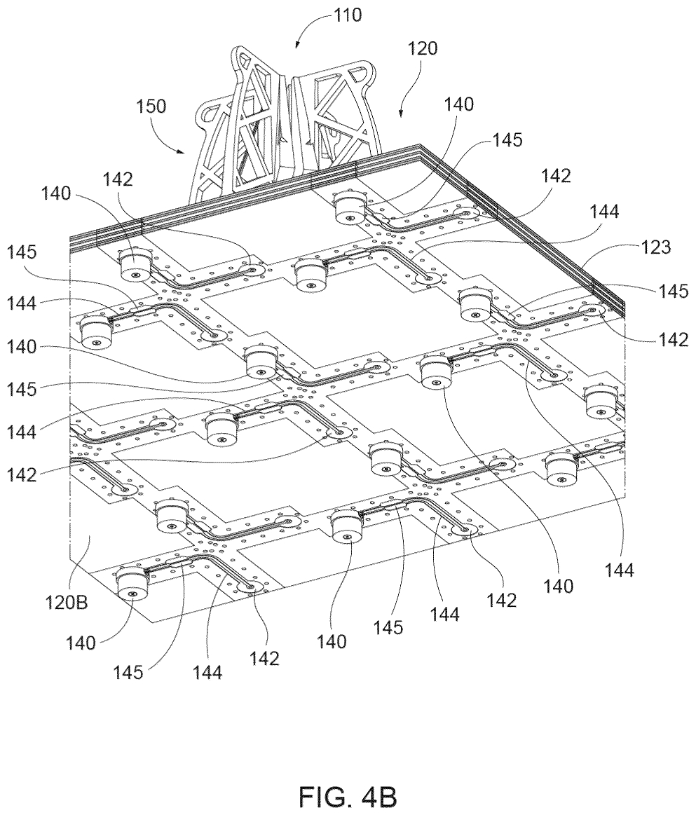

FIG. 4A is a top perspective view of a representative (notional) radiator feed and translation fecder board (or circuit board) 120 for a broadband array, looking down at the radiator side (top surface) 120A (that is, the surface on which monolith 110 is mounted). FIG. 4B is a bottom perspective view of the circuit board 120, looking up at the feed side (bottom surface) 120B (opposite monolith 110).

Circuit board (feeder board) 120 is a second major component of the broadband radiator array. FIG. 4A is shown depopulated to highlight a single intra-element monolith 110. In particular examples, circuit board 120 can be described as a RAFT (Radiator Feed and Translation) type circuit board 120 for an IMPACT (Intra-element Monoliths Printed And attached to a CircuiT board) array 100.

Each monolith 110 has four transversely oriented impedance matching elements 150, arranged symmetrically about a central axis A. In this particular configuration, for example, four tapered slot edge type impedance matching elements 150 extend along axis A from the central base 160 to the top portion 112 of monolith 110; e.g., extending vertically from the shoring posts 164 coupled to base frame or mount 161, and laterally outward from the axis A to tapered sections 154, defining the radially outer edge of each impedance matching element 150. Tapered sections 154 extend from the leg section 151 on the bottom portion 111 of monolith 110, defining a fluted geometry through the flared section 156 at the top portion 112. One more impedance tuning features 155 can be provided in tapered section 154 or flared section 156, and capacitive/reinforcing structures 158 can be provided on the leg section 151; e.g., between the foot 152 and tapered section 154, as described above.

The central base 160 of each monolith 110 can be shorted to ground, and provided with a base frame or mount structure 161 for mounting monolith 110 to the circuit board 120; e.g., with one or more alignment bars 162 to maintain spacing and orientation between adjacent monoliths 110. For example, bars 162 can be provided with locating/alignment pins 163 as shown in FIG. 3, protruding vertically down into precision locator holes 166 in the top surface of circuit board 120, in order to fix the location and rotational orientation of each monolith 110, and maintain the corresponding spacing and angular orientation between adjacent monoliths 110 when coupled to a circuit board.

As shown in FIG. 4A, a number of active connectors 122 are provided to drive the radiator sites defined in the gaps between opposing impedance matching elements 150 on neighboring monoliths 110 (or to receive signals generated in the gaps). For example, signal connections can be made to the two “driven” legs 151 on each monolith 110 via connectors 122, and the respective passive or “parasitic” legs 151 can be connected to a ground or signal ground plane 123; e.g., via one or more solder pads 124.

In the particular example of FIGS. 4A and 4B, each driven leg 151 of the monolith 110 can be positioned next to a passive leg 151 of the neighboring monolith 110, so that the gap between the opposing impedance matching elements 150 defines the radiating site. Circuit board 120 can also be provided with any number of conductive ground or signal planes 123, adapted for making electrical connections to legs 151 and base 160 of monolith 110.

As shown in FIG. 4B, signal connectors 140 are provided on the underside (bottom surface) 120B of circuit board 120, in order to drive the active legs of the monoliths 110 on the top surface 120A. For example, broadband, coaxial signal connectors 140 can be connected to plated through-vias 142 via transmission lines (or feed lines) 144, each with one or more distributed or lumped inductive tuning features 145. Through-vias 142 extend through circuit board 120 to the active connectors 122 on the top surface 120A, connected the actively driven legs 151 of the monolith 110.

Depending on example, signal connectors 140 can also be directly coupled to the through vias 142 on the bottom surface 120B, extending directly through circuit board 120 to the active connectors 122 on the top surface 120A, without using feed lines 144. Alternatively, any of the via, pad and connector structures can also be provided on an internal layer of circuit board 120, for example between one or more ground planes or signal grounds, as described herein.

More broadly, circuit board 120 serves the functions of feeding (exciting) the radiating sites defined between adjacent intra-element monoliths 110 on the top side of the circuit board 120 (FIG. 4A), as well as translating the location of the signal feeds on the bottom side (or other layer) of circuit board 120 (FIG. 4B) to mate with signal connections and other components (e.g., behind the array, opposite the monoliths 110). In some applications, circuit board 120 can be configured to include multiple printed circuit board (PCB), layers, to provide additional functionality such as feed combining (multiplexing or manifolding), impedance matching, and other signal functions.

In the particular example of FIG. 4A, two of the legs 151 on each monolith 110 are soldered to a pad in the center of active connectors 122 (e.g., one per polarization), and coupled to broadband signal connection (e.g., a coaxial cable). The other two legs 151 can be soldered to a ground pad or ground plane, along with the circular or oblong center monolith base 160. For example, the foot on the bottom of each leg 151 in an adjacent (orthogonal or right angle) pair of impedance matching elements 150 can be connected to a signal via connectors 122. Similarly, the fect at the bottoms of each leg 151 in the opposing right-angle pair of impedance matching elements 150 can be connected to ground (e.g., a ground plane on the feeder board or circuit board 120).

In this configuration, one impedance matching element 150 in each gap is actively driven (by the signal wire, or incoming radiation), and the other is passively driven (via electromagnetic coupling). Alternatively, parallel pairs of tapered slot edge type impedance matching elements 150 can be coupled to a signal wire, with the orthogonal pairs of impedance matching elements 150 coupled to ground. In these examples, the ground/signal connections may alternate between adjacent monoliths 110, so that one impedance matching element 150 at each radiating site is active. The opposed impedance matching element 150 is passive or parasitic, disposed across the gap between adjacent monoliths 110.

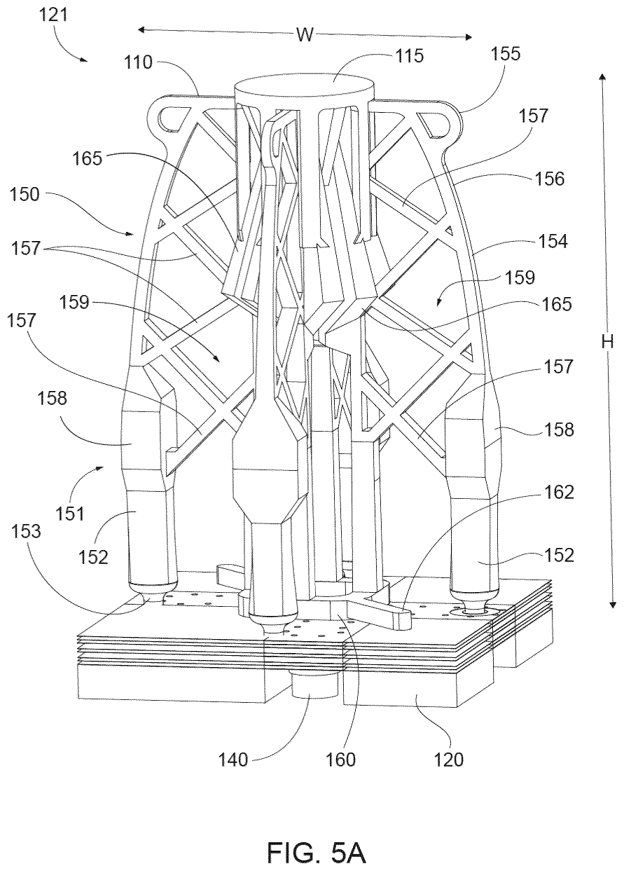

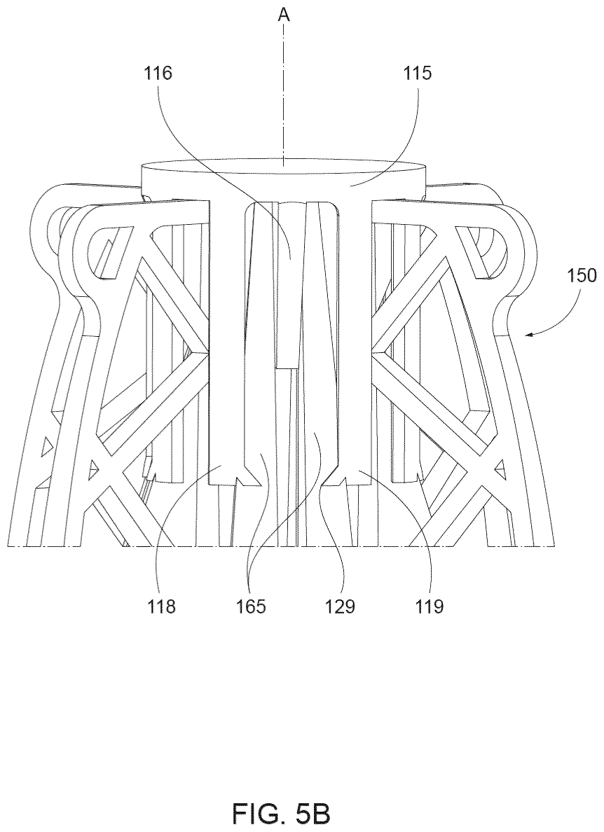

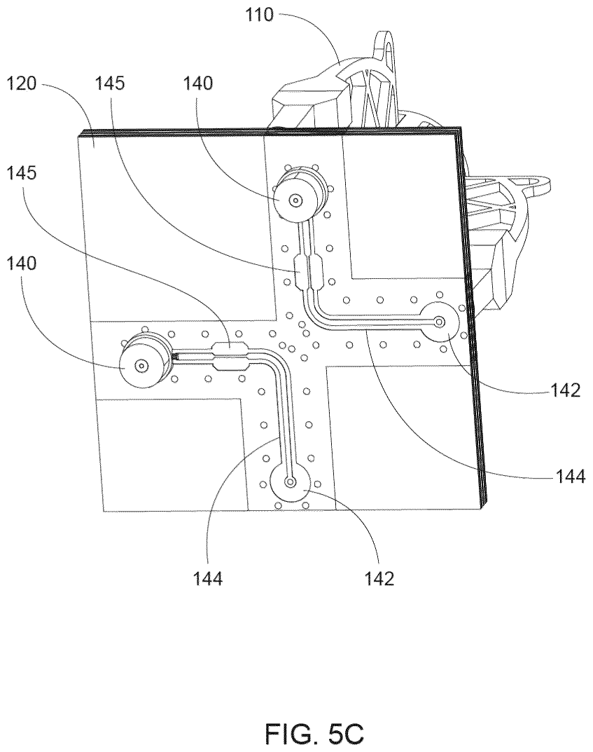

FIG. 5A is an isometric view illustrating a monolithic radiator element feed unit cell 121 as defined for an intra-element monolith 110 disposed on a substrate such as a feeder board or similar circuit board 120. FIG. 5B is a detail view of a dielectric spacer 115 on the intra-element monolith 110, and FIG. 5C is a bottom view of the circuit board 120.

As shown in FIG. 5A, monolith 110 has height H, measured from the top surface of circuit board 120 to the top of spacer 115, and width W, measured across the radially outer edges of opposing impedance matching elements 150; e.g., across legs 151. The foot 152 on the bottom of each leg 151 can be provided with a connector 153, which can be coupled to a signal connector 140 on the bottom of circuit board 120 via a signal aperture, or to a solder pad or ground plane on the top of circuit board 120.

The central base 160 of each monolith 110 can also be connected to a ground plane on circuit board 120. Suitable connection techniques for the base 160 and connectors 153 on monolith 110 include soldering, wave soldering, vapor-phase soldering, and other surface mount techniques.

FIG. 5B shows a dielectric spacer 115 disposed on the top of a monolith 110. In this example, spacer 115 includes a plurality of wedge-shaped spacer features 116, a top cap (or “grabber”) feature 117, and a plurality of elongated resilient coupling features 118. When spacer 115 is positioned with respect to the top portion of monolith 110, spacer features (or “wedges”) 116 can be disposed between the adjacent capacitive coupling structures 165, with cap feature 117 positioned on the top end of monolith 110 and elongated coupling features (or “clamps”) 118 positioned for coupling spacer 115 to monolith 110. For example, coupling features 118 can be elastically biased so that the outward force of the spacer features 116 and the inward force of the coupling features 118 act against each other in static equilibrium to mechanically couple the spacer 115 to monolith 110, with spacer features 116 positioned to maintain spacing between the adjacent capacitive coupling structures 165 and the radially inner portion of the respective impedance matching (tapered slot edge) elements 150 of each monolith 110, on which the respective capacitive coupling structures 165 are disposed.

The elongated coupling features 118 can be configured with a resiliently biased barb, hook, clamp, or “snap-in” engagement 119A on each end, adapted to engage a complementary notch, channel, detent or similar complementary engagement feature 119B in the tapered portion of impedance matching element 150. Coupling (or clamp) features 118 can thus be configured to positively lock or secure the spacer 115 into place on the monolith 110, without the use of additional adhesives or mechanical attachment. Alternatively a friction fitting, biased engagement or similar mechanical attachment can be used, or an adhesive. Cap feature 117 can then be used to position spacer 115 and monolith 110 with respect to a feeder board, circuit board, or other substrate, for example using a pick and place system to grab spacer 115 via the cap feature 117.

In these various configurations, spacer elements 115 can also serve a secondary function as a positional reference; e.g., with cap feature 117 in a disk-shaped or planar configuration as shown, and/or with indicia and coupling features configured to allow each spacer 115 to be identified and located by pick-and-place equipment, providing for automated positioning of monoliths 110 on a feeder board or other substrate. The geometry of cap feature 117 (and other placement features of spacer 115) can be configured for use with automated printed circuit board (PCB) assembly equipment to position each monolith 110, substantially reduce manufacturing costs (e.g., as compared to traditional or manual assembly).

As shown in FIG. 5C, signal connectors 140 are electrically connected to through-vias 142 via feed lines 144 with or without inductive tuning features (or other tuning features) 145. Signal connectors 140 can be configured for broadband signal connections, for example in for form of coaxial connectors or subminiature push-on (SMP) connectors. Signal connectors 140 can also be configured for signal inputs or outputs of different phase or different polarity, or both, and for signals of different amplitude and frequency range.

The transmission lines (or feed lines) 144 and tuning features 145 can be configured to match the effective signal impedance at connectors 140 and through-vias 142. For example, the impedance of feed line 144 may be tapered from approximately 50 ohm (50Ω) at a coaxial signal connector 140 to approximately 70 ohm (70Ω) at the through-via 142.

The height H and with W of monolith 110 vary, depending on desired frequency response and other operational considerations. In one particular example, height H is about 2.145 in (about 54-55 mm), and width W is about 1.4 in (about 35-36 mm). In another example, H is approximately 0.95 in (about 24 mm), and W is about 0.560 in (about 14 mm).

A three-dimensional (3D) electrodynamic software simulation with cost function analysis was used to design a radio-frequency (RF) radiator/receiver/transmitter array with a bandwidth covering about 1-4 GHZ, or about 0.8 GHz to about 4.5 GHZ, about 4 GHz to about 18 GHz, about 2 GHz to about 12 GHz, about 0.35 GHz to about 1.2 GHz, or in a range from about 0.2 GHz to about 20 GHz. A time domain solver was used with periodic boundary conditions to simulate an infinite array of intra-element monoliths 110, and evaluate the performance at boresight (i.e., the axis of maximum gain, normal to the plane of the array). A frequency domain solver with unit cell boundary conditions can also be used to simulate an infinite array of monoliths 110, and evaluate the performance both at boresight as well as at other scan angles. The simulations can include a cost function analysis selected for reducing height and weight, and reducing or minimizing sensitivity to tolerances for areas of the array design, including dimensional tolerances on impedance matching elements (tapered slot edge structures) 150 and other components of individual monoliths 110, the inter-element spacing between adjacent monoliths 110, and orientation of monoliths 110 on circuit board 120.

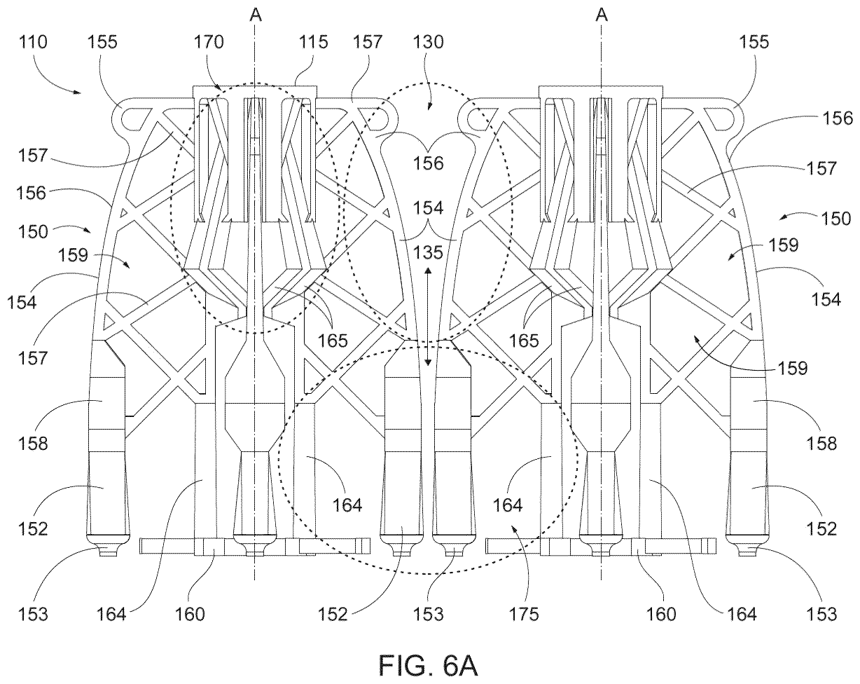

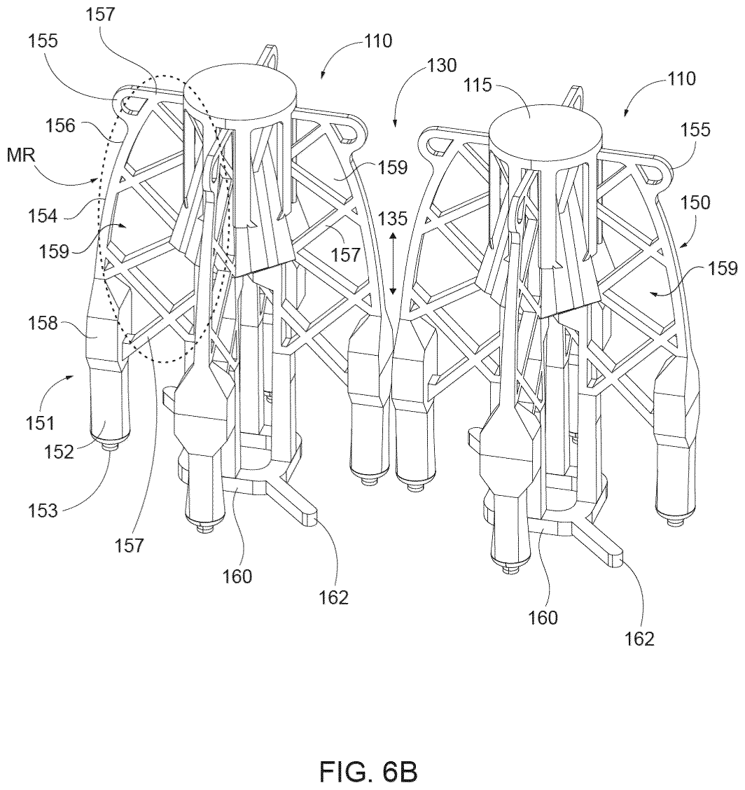

FIG. 6A is a side elevation view of adjacent intra-element monoliths 110 for a broadband array. FIG. 6B is a top isometric view of the adjacent intra-elements monoliths 110.

As shown in FIG. 6A, the gap region 130 between adjacent monoliths 110 is defined by the curvature of the (e.g., Vivaldi-like) tapered sections 154 and/or flared sections 156 of opposing impedance matching elements 150. Radiating sites (or receiver/transmitter sites) 135 are defined in the gap regions 130, extending from between the legs 151 and capacitive/reinforcing structures 158 of adjacent monoliths 110, through the tapered and flared sections 154, 156 in the upper region of gap 130, and into the free space outside (above) the gap 130.

Banyan roots or shorting posts 164 extend vertically from the base 160 of each adjacent monolith 110, along the central axis A. This defines a feed balun region 175 in the lower region of gap 130, between the legs 151 of adjacent monoliths 110. The connectors 153 on feet 152 can be coupled to signal and ground, respectively, defining the driven (signal) and passive (or parasitic) legs 151; that is, so that the respective impedance matching elements 150 are operable in an actively driven manner and in a passively driven manner, respectively.

A dielectric spacer 115 is disposed on the top of monolith 110, extending along central axis A between the adjacent “wall” shaped capacitive coupling structures 165. Spacer 115 and capacitive coupling structures 165 define a capacitive region 170 of the monolith 110, configured to maintain precise spacing for uniform, “tight” coupling of the adjacent impedance matching elements 150.

FIG. 6B shows the structural bases 160 of each monolith 110 in perspective view, with alignment bar structures 162. Dielectric spacers 115 are disposed on the tops of monoliths 110, opposite the base 160, with spacer, cap, coupling and “grabber” features for coupling to and placing monoliths 110, as described herein (see, e.g., FIG. 5B). Mass-reduction (MR) can be achieved with spaces, apertures, openings, voids or other “lightening” features 159, for example as defined adjacent the corresponding truss or web structures 157. Depending on application, features 159 can be provided in a mass-reducing region MR defined along or inside the tapered and flared sections 154, 156 of each impedance matching element 150. Other mass reducing features 159 can also be provided on or adjacent the capacitive/reinforcement structures 158, in the feet regions 152, on the base 160, or elsewhere on monolith 110.

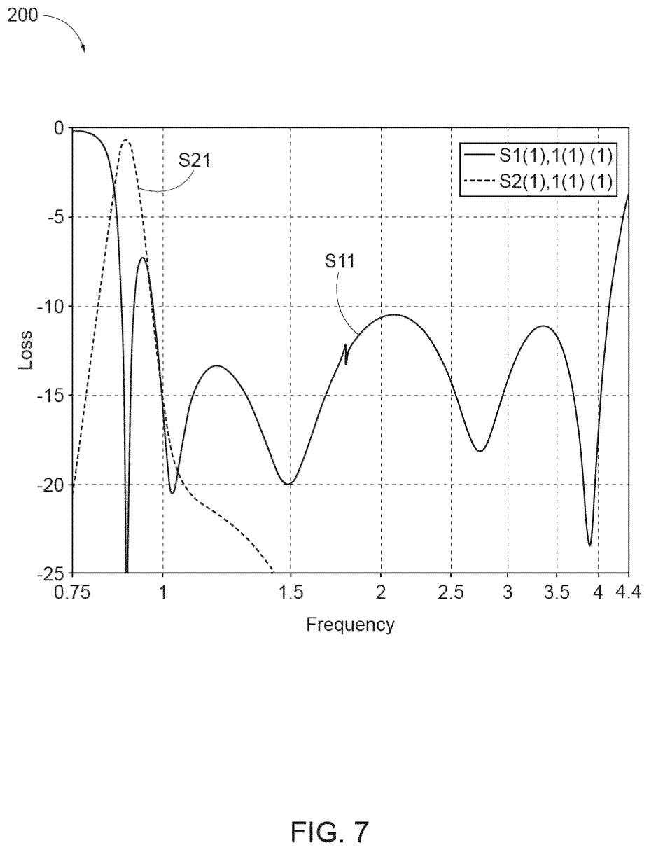

FIG. 7 is representative plot 200 of simulated S-parameters S11, S21 for a broadband array, where ports 1 and 2 correspond to each of the two linear orthogonally polarized ports as described herein. Loss is shown on the vertical axis, for example in decibels (dB). Frequency is shown on the horizontal axis, for example in gigahertz (GHz).

Loss curves S11, S21 represent predicted S-parameters referenced to a signal connection, for example at a subminiature push-on (SMP) connector or similar coaxial or broadband signal connector 140 on the underside of a RAdiator Feed and Translation (RAFT) type circuit board 120, according to FIGS. 5A-5C. Under these conditions, the predictions of FIG. 7 show good operation over a suitable frequency band, for example a band from about 1-4 GHZ.

In particular examples, curve S11 may show a characteristic dip between about 0.75 GHZ and 1.0 GHZ, for example with a loss of approximately −20 to −25 dB (or more), followed by a quasi-periodic loss response oscillating between about −20 dB and −10 dB from 1 GHz to 3.5 GHz. There is another dip to about −20 to −25 dB between 3.5 GHZ and 4.0 GHz, followed by a monotonic rise toward about −5 dB or less between 4.0 GHZ and 4.4 GHz. Signal S21 shows a complementary peak of about −1 to about −5 dB between 0.75 GHz and 1 GHz, then drops below about −20 to −25 dB between 1.0 GHz and 1.5 GHz showing good cross-pol isolation. More generally, between 1 and 4 GHz S11 can be below a particular level; e.g., below about −10 dB (which is a generally accepted “good” figure of merit for antennas). And over this same 1-4 GHZ frequency range, S21 may be below about −20 dB. Note however that a suitable (“good” or “good enough”) figure of merit for S21 tends to be application specific, and there is not necessarily a single universally-accepted number. That said, in some applications-20 dB is considered a suitable, or even respectable, result. Alternatively the array may operate in range from about 0.2 GHz to about 20 GHz, as described herein.

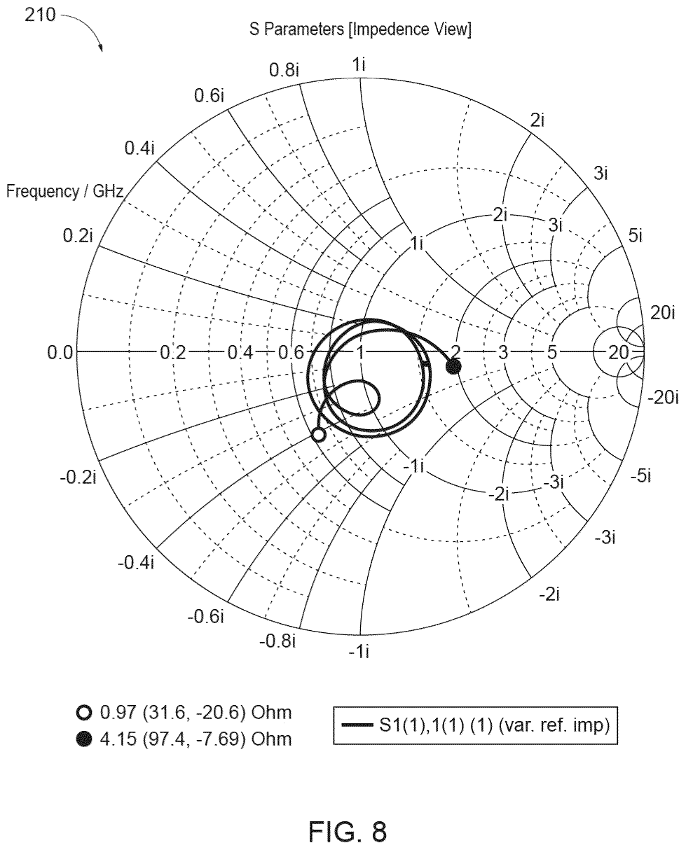

FIG. 8 is representative Smith Chart (or nomogram) 210 for the complex simulated reflection coefficient S-parameter signal S11 of FIG. 7. Although this design was optimized at broadside, a frequency domain solver was used to compute performance with scan and showed suitable performance out to approximately 45° (45 degrees) from normal. With additional operational changes at scan, including changes to the geometry and/or composition of the dielectric spacer, the radiator may perform suitably well to 60° (60 degrees) or further, in one or both polarizations.

### Fabrication and Mechanical Validation

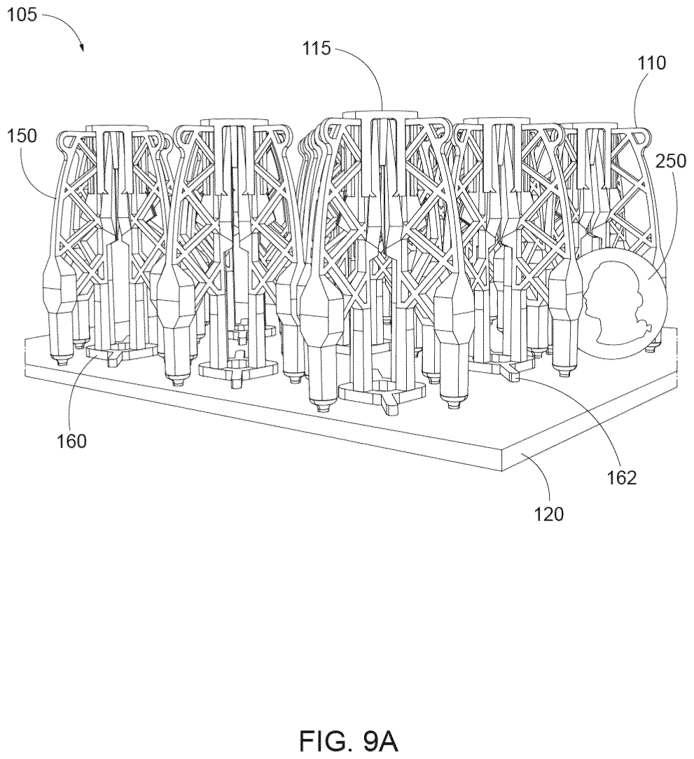

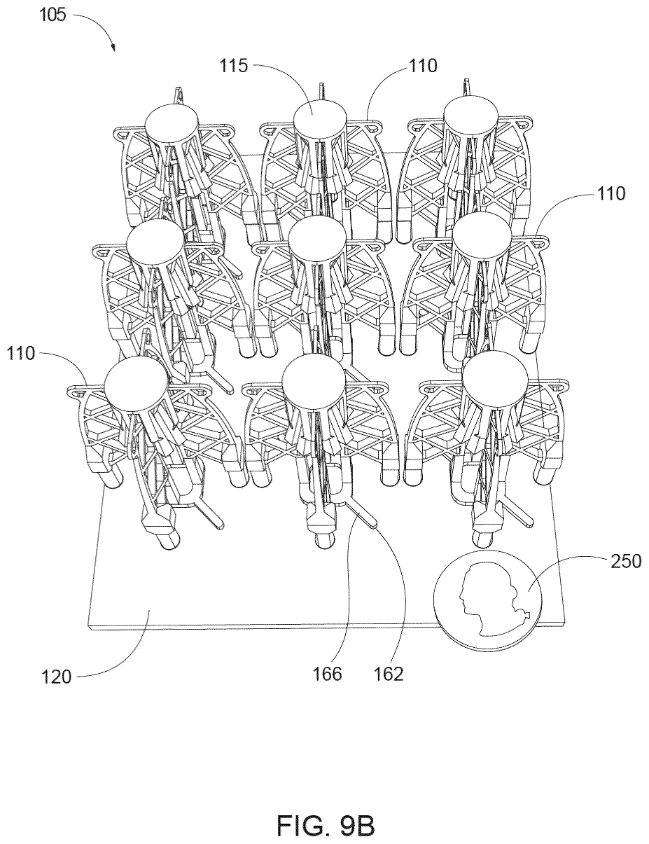

FIG. 9A is a line drawing of a broadband radiator subarray (subunit or “tile”) 105, in side elevation view. FIG. 9B is an alternate perspective of the subarray 105, in plan view. Subarray 105 can be deployed as shown, in a single sub-unit broadband array configuration, or a number of subarrays 105 can be assembled into a larger broadband array 100, using any suitable number of individual intra-element monoliths 110, as described herein.

In the particular example of FIGS. 9A and 9B, subarray 105 is formed in a three-by-three grid of uniformly spaced and oriented intra-element monoliths 110, arranged on the top surface of circuit board 120. A coin or similar scale reference 250 is also shown; e.g., with a diameter on the order of about 1 in (about 25 mm). The reference 250 is merely exemplary, and varies depending on the desired frequency response and other operational parameters of subarray 105.

The central base 160 of each monolith 110 is soldered to a ground plane on circuit board 120. Alignment bars 162 may or may not be provided with pins that can be inserted into precision locator holes in the top of circuit board 120, to locate the physical monolith structure 110 in place and orient as desired. Dielectric spacers 115 can be provided on the top center of each monolith 110, to help maintain spacing and orientation of the four transversely-oriented impedance matching elements 150.

To expedite initial validation of the design concept, a small (3×3) subarray 105 of intra-element monoliths 110 can be constructed as shown. The individual monoliths 110 can be formed by additive manufacturing (e.g., 3D printing), using a suitable material such as aluminum, copper, nickel, steel, titanium, or other metal or alloy thereof, or from material such plastic, polymer, or composite material, which is coated with such a suitable metal material. The monoliths can be provided with one of more coatings, for example with about 50 micron (50 μm, or 50×10⁻⁶ m) of a material selected for solderability, such as nickel, and about 10 micron (10 μm, or 10×10⁻⁶ m) of material selected for conductivity, such as copper.

The materials and manufacturing techniques used to produce monoliths 110 may also vary, depending on application. Other suitable structural and coating materials include aluminum, titanium, steel, copper, tin, silver, gold and other conducting metals, and alloys thereof. Suitable solderability and conductivity coating thicknesses can range from 5 micron (5 μm) or less up to 50 μm or more.

Fabrication of a subarray 105 or array 100 can be performed using advanced electronics manufacturing processes, for example with a suitable solder and rosin mildly activated (RMA) flux chemistry solder paste printed onto the circuit board 120 for forming electrical connections to monoliths 110. In one particular example, a tin/lead solder was used, for example a 63% Sn (tin) and 37% Pb (lead) solder material.

Monoliths 110 can be manually positioned, or positioned with automated pick-and-place system or robotic apparatus. The solder material can be reflowed to secure the monoliths 110 to the circuit board 120, with selected electrical connections. After reflowing and initial testing, the subarray (or assembly) 105 can be washed to improve part cleanliness for the next level of assembly into a radiator or sensor system, for example using aqueous wash techniques.

The construction of monoliths 110 is designed to provide surface mount device (SMD) compatible components. The design process takes into consideration the positioning of solderable surfaces for forming electrical connections to circuit board 120, and coefficient of thermal expansion (CTE) characteristics of the monolith construction 110. Suitable robustness testing techniques include vibration testing (e.g., on all or a random sample of manufactured subarrays 105), hot and cold non-operational and/or operational survival testing (e.g., from −65 C or less to +150 C or more), and solder joint fatigue life demonstration testing (e.g., from −40 C or less to +100 C or more). After predefined intervals in the mechanical tests, the subarray 105 may also under radio-frequency (RF) testing to verify performance, and to verify the subarray 105 has not degraded.

Suitable subarrays 105 of intra-element monoliths 110 can survive a series of mechanical tests with no substantial signs of RF performance degradation. Suitable tests include vibration on each of two lateral orientation axes, periods (e.g., 1 hour, 4 hours, 8 hours, or 24 hours or more) at each extreme temperature for non-operational and/or operational survival testing (e.g., −55 C or less up to +100 C to +150 C or more), and solder joint fatigue life testing (e.g. multiple rounds of two, four, six or more). Suitable solder joint fatigue life demonstration testing may also include up to twenty cycles from hot to cold, in the temperature ranges described herein.

Two-port S-parameter data files can also be collected for up to six or more different combinations of array ports, at various stages of mechanical testing, and compared to a pre-test baseline. In suitable subarrays 105, no substantive change in either amplitude or phase was observed, for relevant self and mutual coupling terms. Testing to failure can also be applied; e.g., continued additional testing to more stringent requirements until mechanical or operational RF failure is observed. The test program can also provide engineering confidence in the ability of the array construction to satisfy environmental requirements necessary for integration onto aerospace platforms, and other rigorous industrial specifications.

### Rf Testing

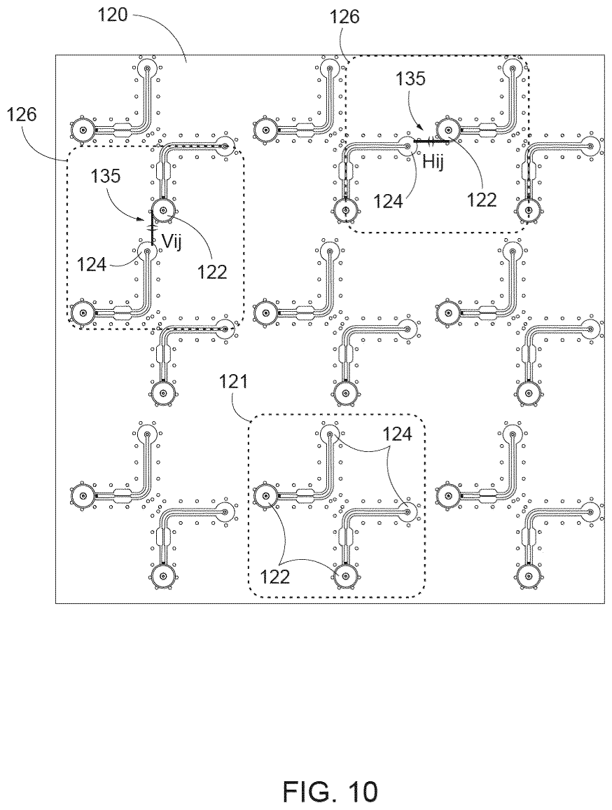

FIG. 10 is a plan view of a three-by-three section of a feeder board or circuit board 120 for a broadband radiator array. The radiator element feed unit cells 121 are defined on the same grid as the intra-element monoliths 110 that are placed on the opposite side of the circuit board 120; e.g., by coupling to selected active connectors 122 and solder pads 124 as shown in FIGS. 5A-5C. Radiator site unit cells 126 are defined by the radiating sites (or receiver/transmitter sites) 135 between adjacent monoliths, offset exactly one half of a cell spacing in both x and y from the positions of the element feed unit cells 121.

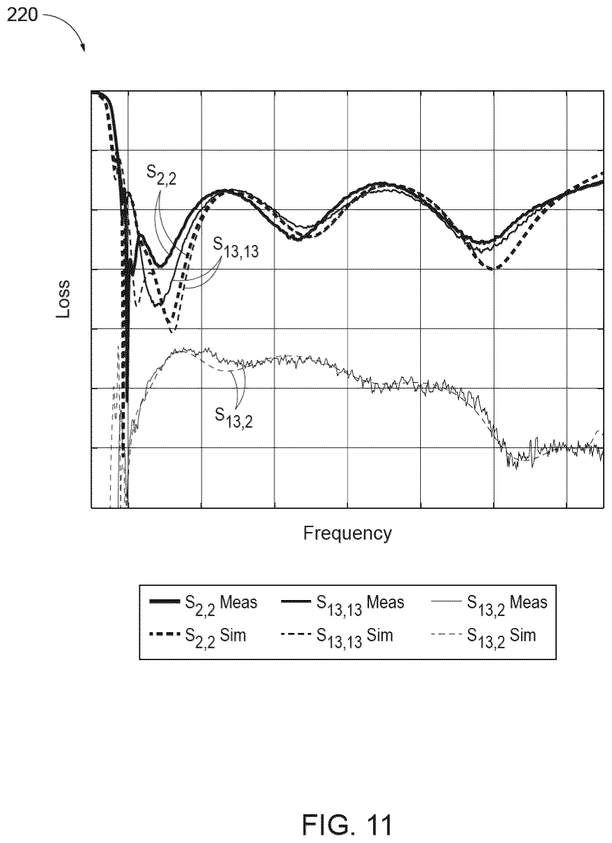

FIG. 11 is representative plot 220 of measured and simulated S-parameters (e.g., self and mutual terms), for a set of ports in a broadband radiator array. Measured (solid) and simulated (dashed) results are shown for representative signals S_{2,2}, S_{13,13}, and S_{13,2}, with S-parameters on the vertical axis (for example in decibels; e.g., from 0 to about −35 dB or less), and frequency on the horizontal axis (for example in gigahertz; e.g., from about 1 GHz or less to about 4 GHz to about 10 GHz or more).

The agreement between measurement and simulations shown in FIG. 11 is typical of what is observed for suitable broadband arrays, as described herein. Because the intra-element monoliths in smaller arrays lack the same level of support from mutual coupling to extended neighbors in larger arrays, they may not exhibit a 2:1 Voltage Standing Wave Ratio (VSWR) over the full design frequency band. That may be acceptable, depending on application, because even smaller arrays are capable of radiating energy over the desired bandwidth, and both the measured self and mutual terms agree with simulations. Similarly, the active impedance in larger array environments can agree well with the well-matched “infinite” array simulations.

Construction of larger arrays facilitates larger array verification measurements. For connectorized stand-alone arrays, testing can include embedded element patterns and active impedance versus scan (e.g., generated via a coherent sum of mutual coupling measurements from a center element to multiple surrounding rings). Actively fed full array patterns versus scan testing can also be employed.

As described herein, a broadband, relatively low profile phased array radiator (or receiver or transmitter) structure comprises a number of individual, additively-manufactured metallic “monoliths” married to a printed circuit board. The structure provides for low-cost, high-volume production, and automated manufacturing processes to enhance producibility, reproducibility, maintaining dimensionality, tolerance and ruggedness with reduce cost. Initial measurements can be used to validate these design concepts, which are also applicable to building and testing larger-scale arrays with further verification of improved RF and mechanical performance.

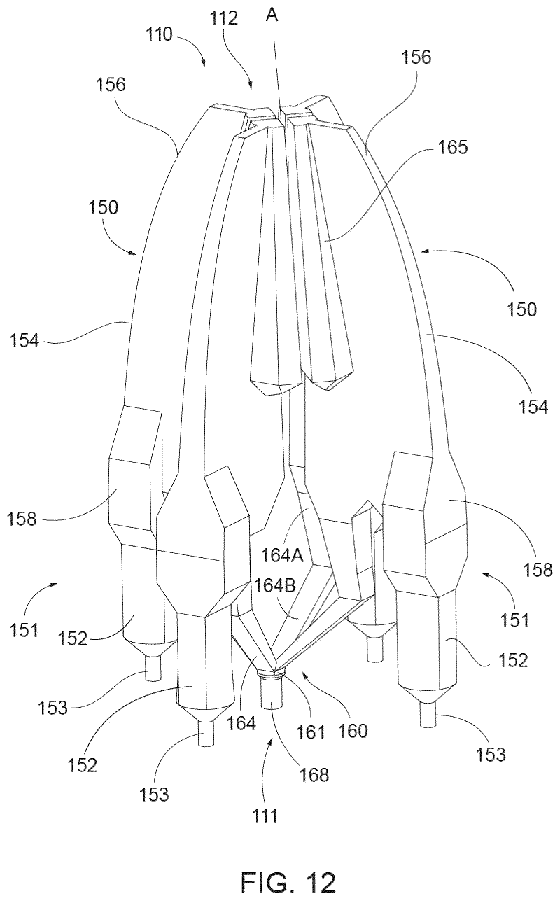

FIG. 12 is an isometric view of an alternate intra-element monolith 110. In this particular example, shorting posts 164 have vertical sections 164A and angled or transverse sections 164B, coupled to a relatively small, generally centrally located base frame or mount structure 161 with a single base connector or base pin 168, for example in an extended, through-pin configuration as shown. Leg sections 151 extend upward from feet 152, which are provided with pin-type connectors 153 configured to extend into or through the top surface of a circuit board for mounting monolith 110.

Impedance matching elements 150 extend from leg sections 151 toward the top portion 112 of monolith 110, from capacitive/reinforcing structures 158 along tapered section 154 to flared section 156. Elements 150 can be formed with truss-like structures 157 defining spaces, openings, apertures or other mass-reducing features 159 (see, e.g., FIG. 3), or elements 150 can be formed as substantially continuous, planar structures. Similarly, tuning features 155 may be present or absent, depending on application, and the configuration capacitive coupling structures 165 may vary, for example in the form of oblong of tapered structures, with substantially parallel walls or similar planar surfaces defining the capacitive coupling between adjacent impedance matching elements 150.

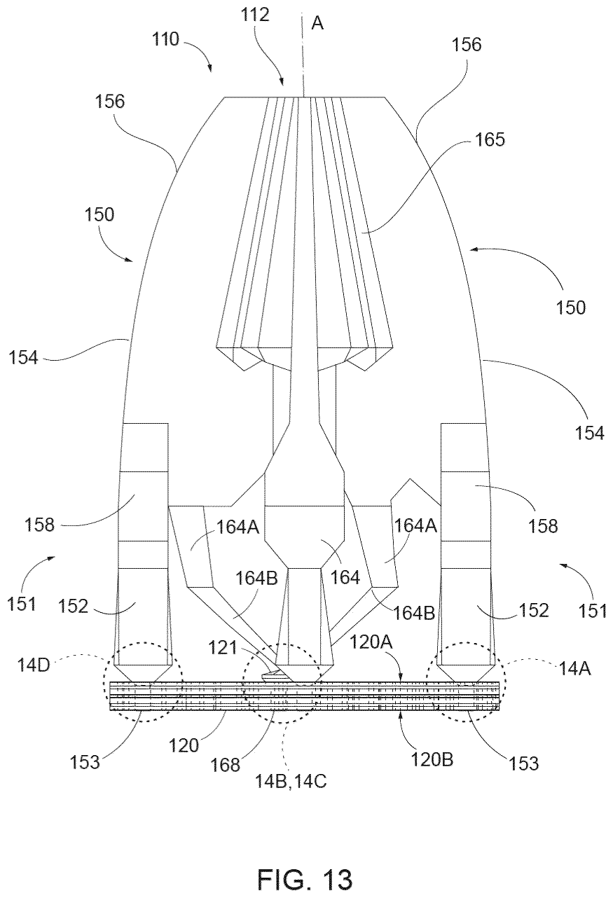

FIG. 13 is a side elevation view of an intra-element monolith 110 according to FIG. 12, mounted onto a feeder board or circuit board 120. As shown in FIG. 13, pin connectors 153 may extend vertically from feet 152 into the top surface 120A of board 120, or substantially through board 120 to the bottom surface 120B as shown. Base pin 168 can be similarly configured, extending from the mount 161 into the top surface 120B of board 120, or substantially through circuit board 120 to the bottom surface 120B.

As shown in FIGS. 12, and 13, the base 160 and base frame or mount structure 161 are offset from the center of the footprint of monolith 110, as defined by the geometric centers of leg sections 151 and feet 152 with connectors 153. As a result, shorting posts 164 are asymmetric, with different geometrical configurations for each transverse section 164B, extending between vertical sections 164A and the mount 161. This configuration provides for additional frequency tuning and response capability, and more flexibility in the arrangement of the signal connectors and feed lines on the circuit board 120, as further described below.

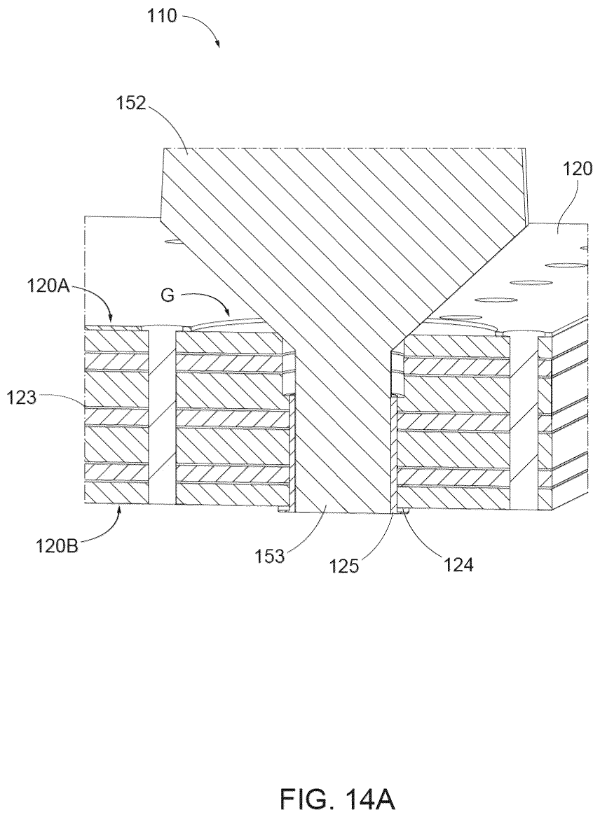

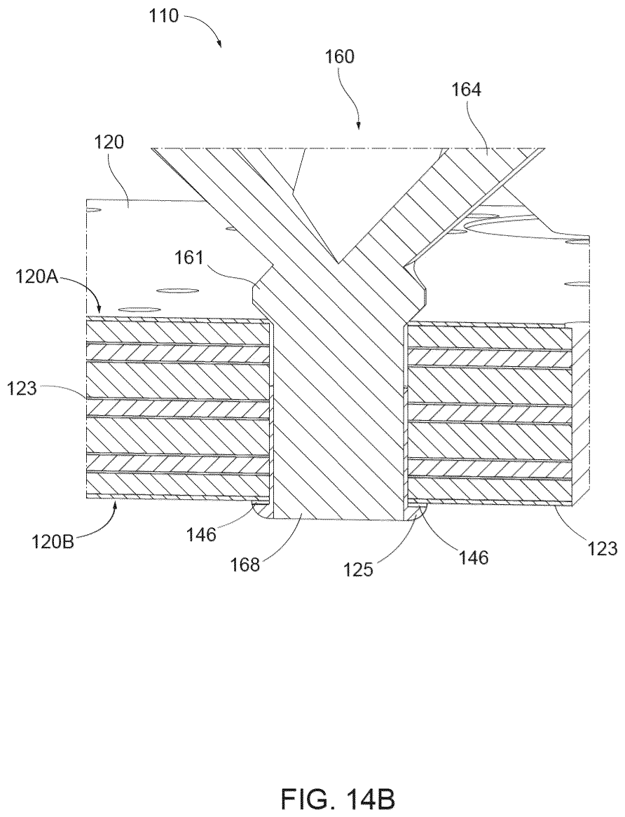

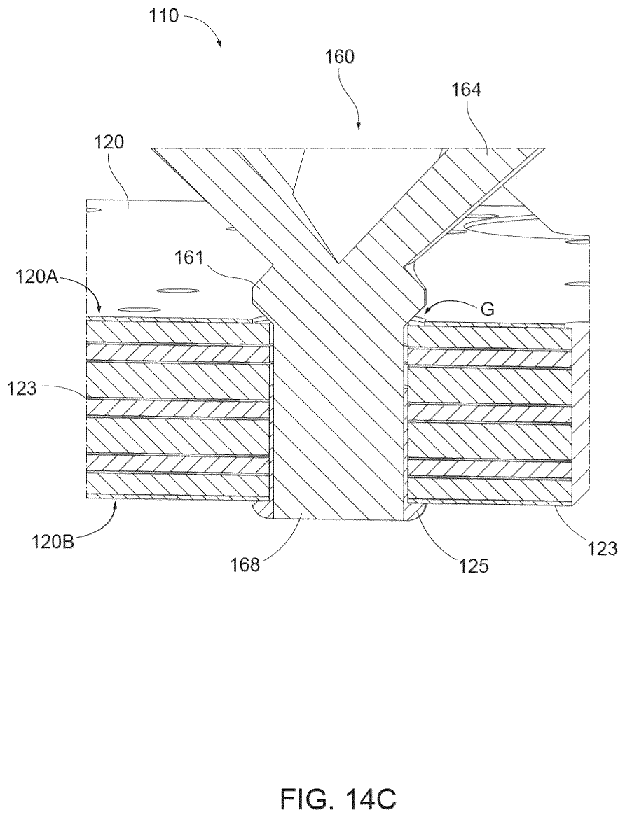

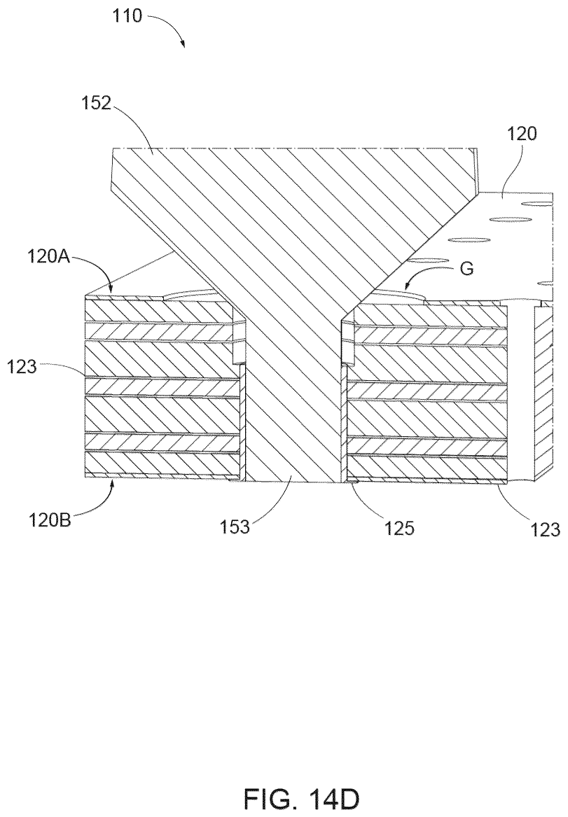

FIG. 14A is a detail section view showing the connector 153 on a foot 152 mounted onto a feeder board or circuit board 120, according to FIG. 13. Foot 152 can be connected to the leg of an intra-element monolith 110, for example according to FIGS. 12 and 13.

As shown in FIG. 14A, pin-type connector 153 extends substantially through the circuit board 120, from top surface 120A to bottom surface 120B. For example, each connector 153 can be electrically or mechanically connected to a solder pad 124 or via 142 on bottom surface 120B of board 120 (or both), using solder 125.

Connector 153 can also be connected to any number of ground planes, signal grounds, or other conductive planes 123 via solder 125, or other suitable electrical or mechanical connection. Depending on application, a gap G can be etched, machined or otherwise formed onto the top surface 120 of circuit board 120, in order to electrically isolate foot 152 and connector 153. For example, a gap G may be provided for actively driven feet 152, but may not be required for the parasitic (passive), or the grounded base mount/frame 161 and base pin 168.

The gap G may also be extended through top surface 120A into the interior of circuit board 120, for example via milling or etching, so that connector 153 is selectively isolated from and coupled to individual ground or signal planes 123, as desired.

FIG. 14B is a detail section view showing a base pin 168 mounted to a feeder board or circuit board 120, for example on an intra-element monolith 110 according to FIGS. 12 and 13. As shown in FIG. 14B, base pin 168 extends vertically from the mount 161, which is coupled to one or more shorting posts 164 to define the base 160 of the monolith 110.

In this particular example, pin-type base connector 168 extends substantially through circuit board 120, from top surface 120A to bottom surface 120B. The base pin 168 can be electrically or mechanically connected (or both) to a suitably grounded base connector 146, for example a connector 146 tied to a ground plane 123 on the bottom surface 120B of circuit board 120, as shown in in FIG. 14B, using solder 125 or another suitable connection.

FIG. 14C is a detail section view showing a base pin 168 mounted to a feeder board or circuit board 120, for example on the base 160 of an intra-element monolith 110 according to FIGS. 12 and 13. As shown in FIG. 14C, base pin 168 can be directly coupled to ground plane 123 on the bottom surface 120B of circuit board 120, or a suitable base connector 146 can be provided as shown in FIG. 13B. A gap G can also be defined on the top surface 120A of circuit board 120, and/or extending into the interior of circuit board 120, so that base pin 168 can be selectively coupled to and isolated from additional ground or signal planes 123.

FIG. 14D is a detail section view showing the connector 153 on a foot 152 of an intra-element monolith 110 mounted to a feeder board or circuit board 120, for example according to FIGS. 12 and 13. In this example, connector 153 can be selectively isolated from ground and signal planes 123 on the top surface 120A and interior or circuit board 120, and electrically and mechanically coupled to a ground or signal plane 123 on bottom surface 120B. Alternatively, connector 153 can be coupled to a grounded pad 124 or via 142, depending on whether the corresponding leg section 151 is configured as an actively or passively driven element, as described herein.

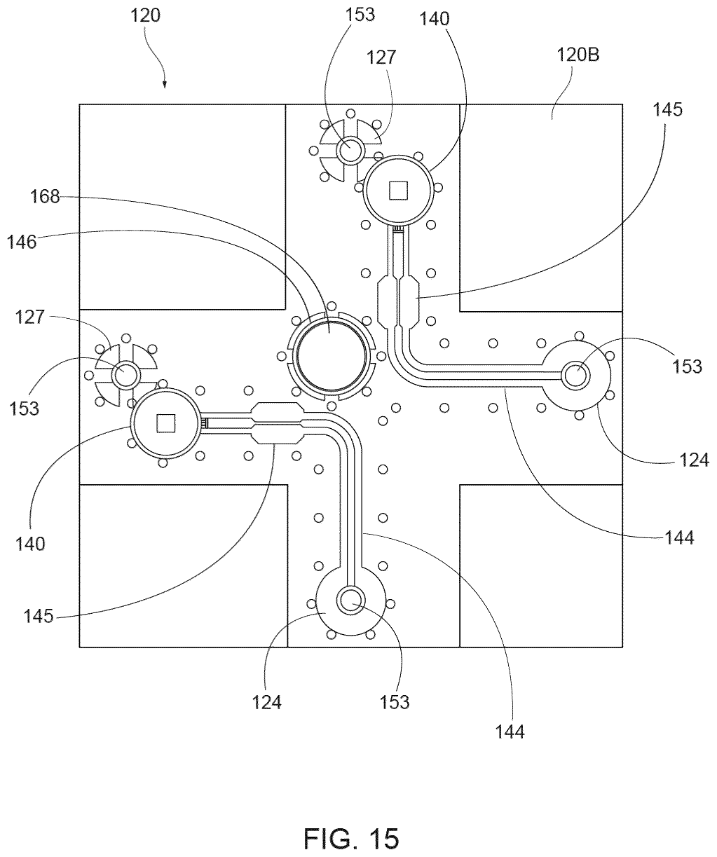

FIG. 15 is a plan view showing the bottom surface 120B of a feeder board or circuit board 120, illustrating an offset base configuration for an intra-element monolith 110; e.g., according to FIGS. 12 and 13. As shown in FIG. 15, signal connectors 140 are provided on the underside (bottom) surface 120B of circuit board 120, for example using broadband, coaxial connectors or other suitable signal connectors 140, as described herein.

Signal connectors 140 can be connected to the active (driven) legs of the monolith via transmission lines (feed lines) 144 extending to solder pad (or via) 124, to which the respective connector 153 is coupled via solder 125, or other suitable electrical and mechanical attachment. Inductive tuning features 145 can also be provided along transmission/feed lines 144, as described herein.

The connectors 153 of passively driven (parasitic) legs can be coupled to a suitable passive connector 127, or tied to a ground plane or signal ground. The base pin 168 is grounded via a grounded connector 146, or by direct connection to a ground plane. Alternatively, these structures can be provided on an internal layer of circuit board 120; e.g., between adjacent ground planes.

As shown in FIG. 15, base connector 146 is offset from the geometric center of connectors 153, corresponding to the offset configuration of base 160, mount 161 and base pin 168 as illustrated in FIGS. 12 and 13. This configuration provides for additional flexibility in the location and geometric configuration of feed lines 144 and tuning features 145, as well as additional tuning capability based on the asymmetric geometry of the shorting posts 164.

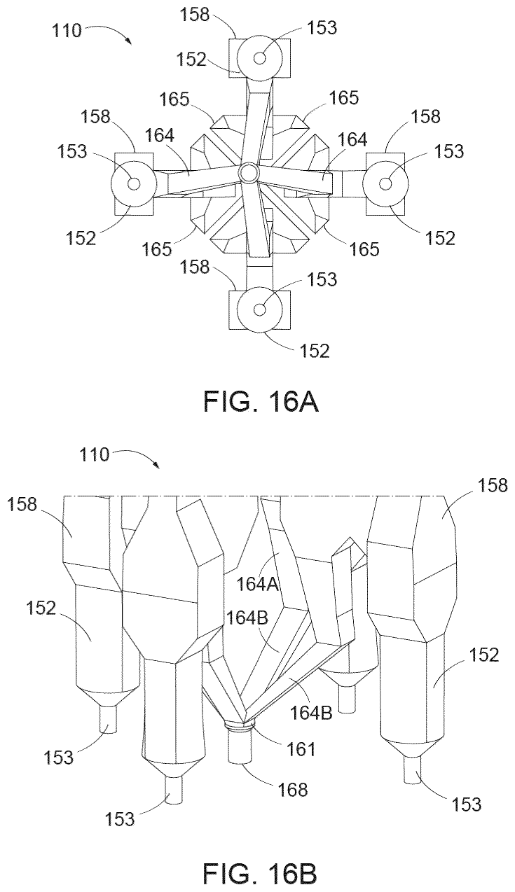

FIG. 16A is a bottom plan view of an intra-element monolith 110; e.g., according to FIGS. 12 and 13. FIG. 16B is an isometric view of the intra-element monolith 110. FIGS. 16A and 16B further illustrate the offset structure of base 160, with asymmetric shorting posts 164 each having a vertical section 164A and a transverse section 164B extending to the base frame or mount structure 161. In this configuration, the base frame or mount structure 161 is coupled to a single base pin 168, and offset from the geometrical center of monolith 110 for improved tuning and mounting capability, as described herein.

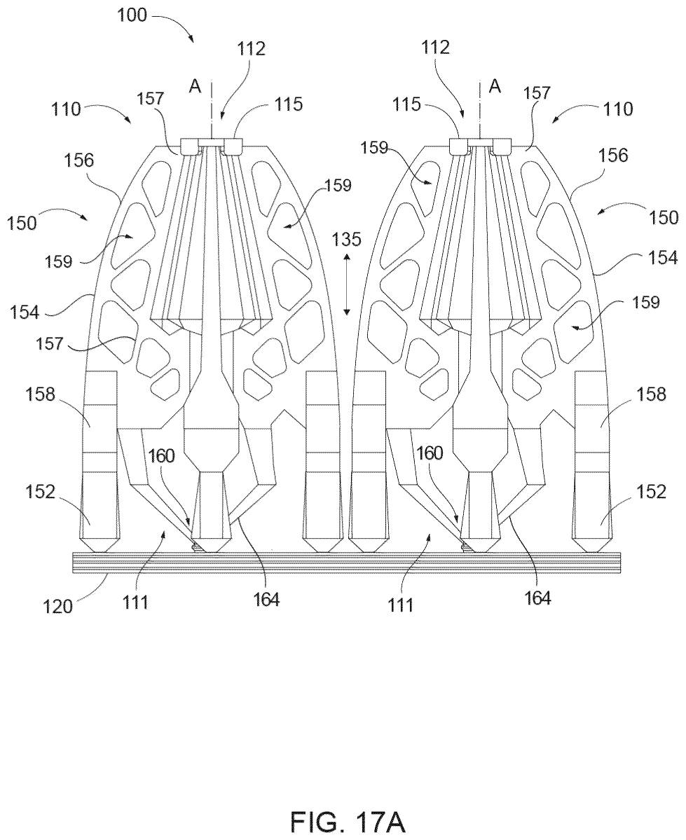

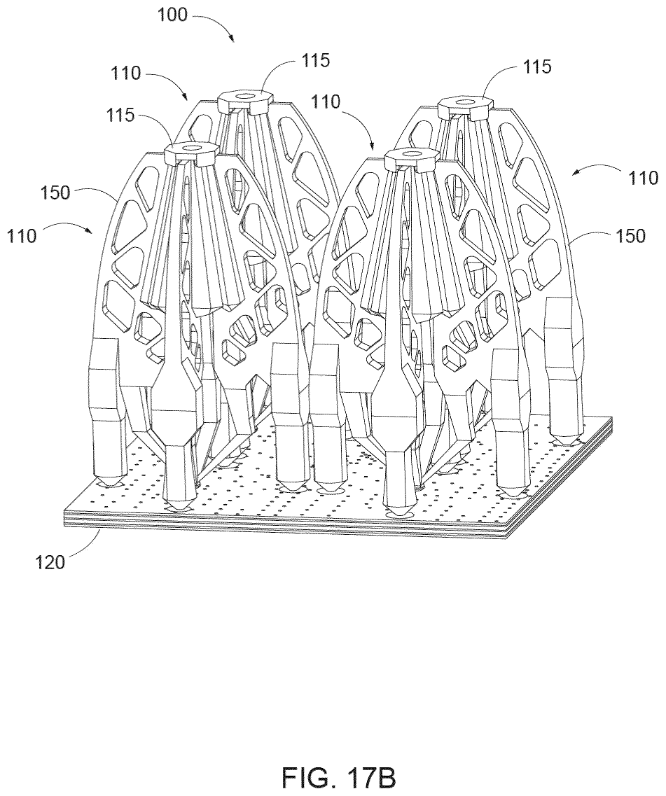

FIG. 17A is a side elevation view showing a set of intra-element monoliths 110 according to FIG. 12; e.g., coupled to a feeder board or circuit board 120 according to FIG. 13. FIG. 17B is a perspective view showing the set of intra-element monoliths 110 coupled to the circuit board 120; e.g., in order to form a broadband array 100, as described herein.

As shown in FIGS. 16A, 16B, 17A and 17B, each monolithic element 110 includes a base 160 defining a base frame or mount structure 161, and a plurality of shorting posts 164 coupled to the base 160. The shorting posts 164 are coupled to a plurality of impedance matching elements 150, each comprising a tapered section 154 extending from a leg section 151 spaced laterally from the respective shorting post 164. A plurality of capacitive coupling structures 165 are coupled to the impedance matching elements 150, and configured for capacitive coupling between adjacent pairs of the elements 150.

The impedance matching elements 150 are configured to define radiator, receiver or transmitter sites 135 between opposing impedance matching elements 150 on the adjacent monolithic elements 110. The legs of one adjacent pair of the impedance matching elements 150 are configured for coupling to a signal connector, so that the first pair of impedance matching elements are actively driven. The legs of a second adjacent pair of the impedance matching elements are configured for coupling to ground, so that the second pair of impedance matching elements are passively driven.

The monolithic elements 110 can include one or more locating/alignment pins 163 coupled to the base frame or mount structure 161 along respective alignment bars 162 (see, e.g., FIG. 3), or a base pin 168 coupled directly to the mount 161. The pins 163, 168 can be configured to maintain spacing and/or rotational alignment between the adjacent instances of the monolithic element, for example by placement into precision holes in the circuit board 120.

The leg sections 151 of the monolithic elements 110 can include feet 152 with connectors 153, configured for coupling the respective legs to the signal connector or ground, respectively. The shorting posts 164 can be connected to a base frame or mount structure 161 disposed on the bottom portion 111 of each monolithic element 110, extending upward from the base 160 toward the top portion 112. The configuration of base frame or mount structure 161 may vary, for example an oblong frame structure as shown in FIG. 3, or a smaller mount 161 extending to a base pin 168, as shown in FIGS. 16A and 16B.

At least one of the shorting posts 164 can be formed of first and second sections 164A and 164B, extending in different directions between the respective impedance matching elements 150 and the base 160, for example with a vertical section 164A extending from an inner portion of the impedance matching element 150, and a transverse section 164B extending from the vertical section 164A to the base frame or mount structure 161.

The base 160 can be asymmetrically disposed between the leg sections 151, for example with the mount 161 being offset from the center of geometry of the feet 132. A capacitive structure or reinforcement can be disposed on each of the leg sections 151, for example between the feet 132 and the tapered sections 154 of the impedance matching elements 150.

The feet 152 can include pin-type connectors 153, configured for mechanically attaching the monolithic element through the circuit board 120. For example, connectors 153 can extend through the circuit board 120, from the top surface 120A to the bottom surface 120B. Alternatively, connectors 153 can extend partway into the circuit board 120, or be configured for mounting monolithic elements 110 to the top surface 120A.

One or more spaces, openings or apertures 159 can be defined in each of the impedance matching elements 150, for example as configured for reducing mass of the monolithic elements 110. A plurality of truss, web or strut features 157 can be defined between the mass-reducing features 159, configured for providing structural integrity to the monolithic elements 110, while maintaining signal response of the radiator, receiver or transmitter sites 135.

The impedance matching elements 150 can define a tapered slot edge geometry, extending from the respective leg sections 151 toward the top portion 112 of each monolithic element 110. The impedance matching elements 150 can be as Vivaldi structures, or adapted to provide Vivaldi functionality for the radiator, receiver or transmitter sites 135.

The monolithic elements 110 can each have four impedance matching elements 150; e.g., disposed symmetrically or with bi-lateral symmetry about the central axis A, and extending radially outward to the tapered section 154. A flared section 156 can also be defined on each impedance matching element 150, between the tapered section 154 and the top portion 112 of the monolithic element 110.

The tapered section 154 and the flared section 156 can define different curvatures along the outside edge of the respective impedance matching elements 150. A tuning element can be defined on either the tapered section 154 or the flared section 156 of each impedance matching element 150, for example where the tuning elements 154 define a change in the respective curvature.

The capacitive coupling structures 165 can have substantially planar surfaces oriented parallel to one another on the adjacent pairs of impedance matching elements 150. A dielectric spacer 115 can be disposed on the top portion 112 of each monolithic element 110; e.g., extending between the adjacent pairs of impedance matching elements 150, and/or the corresponding adjacent capacitive coupling structures 165. The dielectric spacers 115 can be mechanically attached or adhered to the monolithic elements 110, and configured for manipulation of the monolithic element by an automated placement system; e.g. when mounting monoliths 110 onto circuit board 120.

For example, dielectric spacers, caps or “grabbers” 115 can be bonded to the top of each monolith 110 using an adhesive, or spacers 115 can be mechanically attached using a friction-based or biased coupling between adjacent impedance matching elements 150. The spacers 115 can have a range of different physical configurations, with relatively longer or shorter height long the central axis A of each monolith 110.

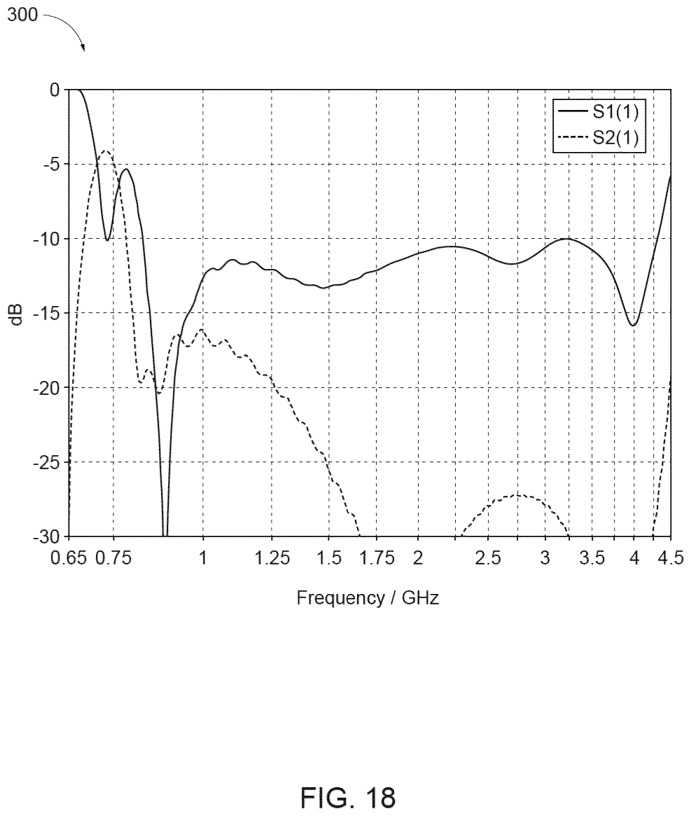

FIG. 18 is a representative plot 300 of simulated S-parameters S1(1) and S2(1) for a broadband array; e.g., according to FIGS. 17A and 17B, and corresponding to the two linear orthogonally polarized ports, as described herein. Loss is shown on the vertical axis, for example in decibels (dB). Frequency is shown on the horizontal axis, for example in gigahertz (GHz).

Loss curves S1(1), and S2(1) represent predicted S-parameters referenced to a signal connector. The predictions of FIG. 18 show good operational performance over a suitable frequency band, for example in a band from about 0.65-4.5 GHZ, or in a range from about 0.2 GHz or less to about 20 GHz or more.

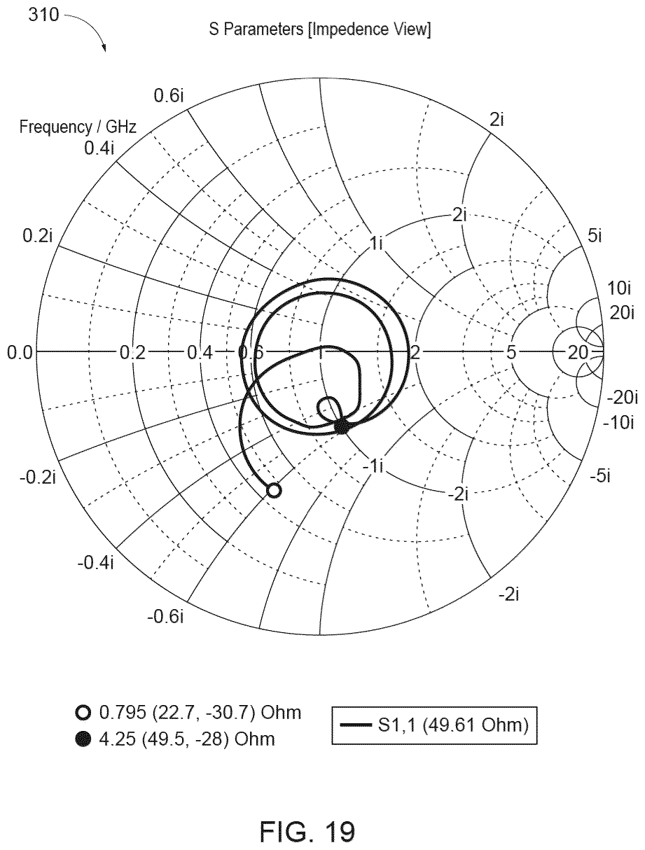

FIG. 19 is representative Smith Chart (or nomogram) 310 for the complex simulated reflection coefficient S-parameter signals of FIG. 18. Using a frequency domain solver or similar technique to compute performance, FIG. 19 indicates suitable response out to approximately 45°(45 degrees) from normal, or up to 60° (60 degrees) or further from normal, in one or both polarizations.

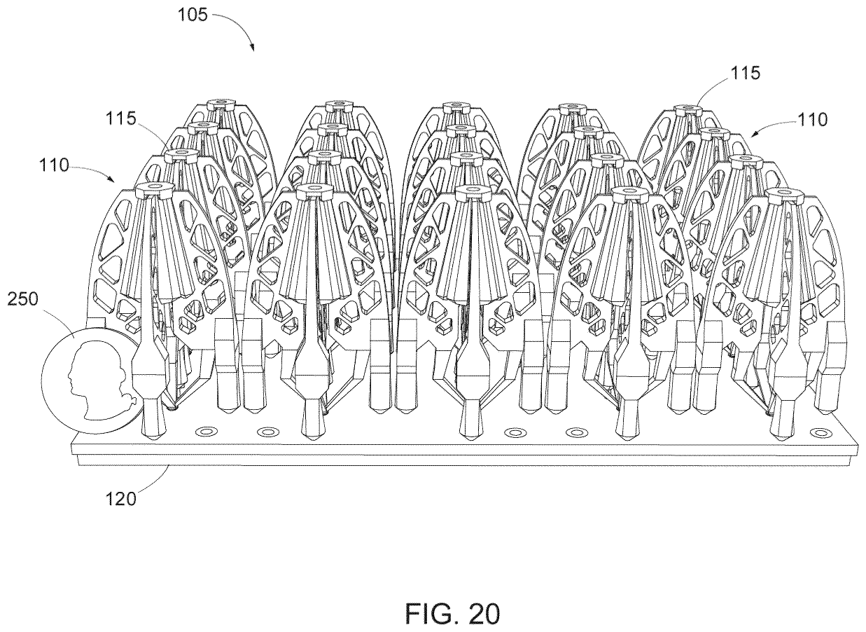

FIG. 20 is a perspective view a broadband subarray (subunit or “tile”) 105; e.g., formed of a number of intra-element monoliths 110 coupled to a circuit board 120 according to FIGS. 12 and 13. FIG. 20 illustrates that the number of monoliths 110 in subarray 105 may vary, for example up to twenty or more monoliths 110 arranged on a circuit board 120 in up to four or more rows, and up to five or more columns. Subarray 105 can be deployed and utilized as shown, forming a single-subunit broadband array, or a larger broadband array can be formed by arranging a number of subarrays 105 together, for example in a two-dimensional tiled pattern, with each tile formed of a single subarray 105.

As shown in FIG. 15, FIGS. 16A and 16B, FIGS. 17A and 17B, and FIG. 20, broadband array 100 is formed from a plurality of intra-element monoliths 110 disposed on a suitable feeder board or circuit board 120. Each monolith 110 has a base 160 defining a base frame or mount structure 161 and a plurality of shorting posts 164 extending from the base frame or mount structure 161 to a plurality of impedance matching elements 150.

The impedance matching elements define tapered slot edge structures extending along a tapered section coupled to a leg section 151, spaced laterally or radially from the shorting posts 164 and base 160. A plurality of radiator, receiver or transmitter sites 135 are defined between opposing impedance matching elements 150 defined as tapered slot edges on the adjacent instances of the intra-element monoliths 110, when disposed on the circuit board 120 to form the broadband array 100.

A plurality of signal connectors 140 can be provided on the circuit board, and coupled to the leg sections 151 of a first set of adjacent pairs of the impedance matching elements 150 on each intra-element monolith 110; e.g., where the first pairs of tapered slot edges are operable to be actively driven. A plurality of grounded pads 124 or passive connectors 127 can be provided on the circuit board 120, and coupled to the leg sections of a second set of adjacent pairs of the impedance matching elements 150 on each intra-element monolith 110; e.g., where the second pairs of impedance matching elements 150 are operable to be passively driven when the first pair of impedance matching elements 150 are actively driven by the signal connectors. Alternatively, both the active and passive tapered slot edges can respond to radio-frequency radiation incident on the radiator, receiver or transmitter sites 135.

The shorting posts 164 can be adapted to couple each of the impedance matching elements 150 to the base 160 of the respective intra-element monolith 110. The base frame or mount structure 161 can have one or more locating/alignment pins 163 or base pins 168; e.g., as configured to maintain spacing and/or rotational alignment between the adjacent monoliths 110.

The shorting posts 164 can each have a first section 164A extending in a first direction (e.g., vertically) from an inner portion of the respective impedance matching element 150, and a second section 164B extending in a second (e.g., transverse) direction from the first section 164A to the base frame or mount structure 161. The bases 160 can be asymmetrically disposed between the respective leg sections 151, or offset with respect to a central axis A of the respective monolith 110.

The impedance matching elements 150 can be configured as Vivaldi structures, or provide Vivaldi functionality to the radiator, receiver or transmitter sites 135. Each intra-element monolith 110 can include four impedance matching elements 150; e.g., disposed symmetrically about the central axis A.

A foot 152 can be defined on each of the leg sections of the intra-element monoliths, where in the feet are configured to couple the respective intra-element monoliths to the circuit board and to connect the first and second adjacent pairs of the tapered slot edges to the signal connectors and grounded connectors, respectively.

A capacitive structure or reinforcement 158 can be defined on each of the leg sections 151 of the intra-element monoliths 110; e.g., between the foot 152 and a tapered section 154 or flared section 156 of the respective impedance matching element 150. A dielectric spacer 115 can be disposed on the top portion 112 of one or more of the intra-element monoliths 110; e.g., where the dielectric spacer 115 is configured to maintain spacing between the impedance matching elements, along the central axis A.

A method for assembling a broadband array includes disposing a plurality of intra-element monoliths 110 on a suitable feeder board or circuit board 120. Each monolith 110 has a base 160 defining a base frame or mount structure 161 and a plurality shorting posts 164 extending from the base frame or mount structure 161 to a plurality of impedance matching elements 150.

The impedance matching elements 150 each have a tapered section 154 extending from a leg section 151 coupled to an outside edge of the impedance matching element 150, spaced laterally or radially from the respective shorting post 164 and base frame or mount structure 161. A plurality of radiator, receiver or transmitter sites 135 can be defined between the opposing impedance matching elements 150 on adjacent monoliths 110, when coupled to the circuit board 120 to form the array 100.

The method can also include coupling the leg sections 151 of a first set of adjacent pairs of the impedance matching elements 150 on each monolith 110 to a plurality of signal connectors 140 on the circuit board 120; e.g. where the first sets of adjacent pairs of impedance matching elements are operable to be actively driven. The leg sections of a second set of adjacent pairs of the impedance matching elements 150 on each monolith 110 to a plurality of grounded pads 124 or passive connectors 127 on the circuit board 120; e.g., were the second set of adjacent pairs of impedance matching elements are operable to be passively driven.

The method can further include coupling an automated pick-and-place system to a dielectric spacer disposed on a top portion of one of the monoliths; e.g., where the dielectric spacer is configured for maintaining a selected spacing between the respective impedance matching elements, along the central axis A. The monolith can then be placed on the circuit board, using the dielectric spacer.

The method can include locating the monolith 110 on the circuit board 120 by inserting a base pin 168 or one or more locating/alignment pins 163 into a precision hole or aperture in the circuit board 120. The pins 163, 168 can be configured to maintain rotational alignment or spacing (or both) of the monolith 110, with respect to the adjacent monoliths 110.

Disposing the monoliths 110 on the circuit board 120 can include inserting a pin-type connector 153 extending from a foot 152 defined on each of the leg sections 153 into a top surface 120A of the circuit board, or through the top surface 120A to a bottom surface 120B, opposite the top surface 120A. The base 160 of each monolith 110 can be asymmetrically placed on the circuit board 120; e.g., offset from the central axis A of the monolith 110, or offset with respect to the center of geometry of the respective leg sections and feet.

This disclosure is made with reference to particular examples and embodiments. Changes can be made to and equivalents may be substituted for the disclosed elements without departing from the scope of the invention as claimed. Modifications can also be made to adapt these teachings to different industries, materials, technologies, and technical problems, not limited to the particular examples that are disclosed, and encompassing all the embodiments falling within the language of the claims.

TABLE 1
Drawing references

100 broadband array
105 subarray (tile)
110 intra-element monolith
111 bottom portion of monolith
112 top portion of monolith
115 dielectric spacer (“cap”)
116 spacer feature (“wedge”)
117 cap feature (“grabber”)
118 coupling feature (“clamp”)
119A engagement
119B complementary engagement
120 circuit board (feeder board/substrate)
120A top surface of feeder board
120B bottom surface of feeder board
121 radiator element feed unit cell
122 active connector
123 ground/signal ground plane
124 solder pad
125 solder
126 radiator site unit cell
127 passive connector
130 gap region (gap)
135 radiating site (transmitter/receiver)
140 signal connector
142 through-via
144 feed line
145 tuning feature (feeder board)
146 base connector
150 impedance matching element
151 leg section
152 foot (or feet)
153 connector
154 tapered section
155 tuning feature (monolith)
156 flared section
157 truss or web structure
158 capacitive/reinforcing structure
159 aperture, opening (mass reduction)
160 base of monolith
161 base frame/mount structure
162 alignment bar
163 locating/alignment pin
164 shorting post
164A vertical post section
164B transverse post section
165 capacitive coupling structure
166 locator hole
168 base connector (pin)
170 capacitive region
175 feed balun region
200 return loss plot
210 cross-polarization plot (nomogram)
220 S-parameter plot
250 scale reference
MR mass reducing region

1. A monolithic element, comprising:
a base;
a plurality of shorting posts coupled to the base, and extending therefrom;
a plurality of impedance matching elements extending from the shorting posts, each comprising a tapered section extending from a leg section spaced laterally from the respective shorting post;
a plurality of capacitive coupling structures coupled to the impedance matching elements, and configured for capacitive coupling therebetween;
wherein the impedance matching elements are configured to define radiator, receiver or transmitter sites between opposing impedance matching elements on adjacent instances of said monolithic element;
wherein the leg sections extending from a first adjacent pair of the impedance matching elements are configured for coupling to a signal connector, wherein the first pair of impedance matching elements are operable to be actively driven; and
wherein the leg sections extending from a second adjacent pair of the impedance matching elements are configured for coupling to ground, wherein the second pair of impedance matching elements are operable to be excited by the opposing impedance matching elements.

2. The monolithic element of claim 1, further comprising one or more base pins or alignment pins coupled to the base and configured to maintain spacing and/or rotational alignment between the adjacent instances of the monolithic element.

3. The monolithic element of claim 1, wherein the leg sections comprise feet configured for coupling to the signal connector or the ground, respectively.

4. The monolithic element of claim 3, wherein:
the shorting posts are connected to the base on a bottom portion of the monolithic element, extending upward from the base toward a top portion of the monolithic element; or
at least one of the shorting posts comprises first and second sections extending between in first and second different directions between the respective impedance matching elements and the base.

5. The monolithic element of claim 3, wherein:
the base is asymmetrically disposed between the leg sections, or offset from a center of geometry of the feet; or
the feet comprise through-hole connectors configured for mechanically attaching the monolithic element to a circuit board; and/or
further comprising a capacitive or reinforcing structure disposed between each of the tapered sections and the feet.

6. The monolithic element of claim 1, further comprising:
one or more openings or apertures defined in each of the capacitive coupling structures, wherein the openings or apertures are configured for reducing mass of the monolithic element; and/or
a plurality of truss, web or strut features defined between the openings or apertures, configured for providing structural integrity to the monolithic element while maintaining signal response of the radiator, receiver or transmitter sites.

7. The monolithic element of claim 1, wherein the impedance matching elements define a tapered slot edge geometry extending from the respective leg sections toward a top portion of the monolithic element.

8. The monolithic element of claim 1, comprising four of said impedance matching elements disposed symmetrically or have bi-lateral symmetry about a central axis of the monolithic element, and extending radially therefrom, wherein the respective radiator, receive or transmitter sites defined between the opposing impedance matching elements on adjacent instances of said monolithic element are configured for operation in first and second different polarizations, wherein the radiator, receiver or transmitter sites are defined for operation at a radio frequency between 0.2 GHz and 20 GHz.

9. The monolithic element of claim 1, further comprising:
a flared section of each impedance matching element defined between the tapered section and a top portion of the monolithic element, wherein the tapered section and the flared section define different curvatures along an outside edge of the respective impedance matching elements; and/or
a tuning element defined on either the tapered section or the flared section of each impedance matching element, wherein the tuning element defines a change in the respective curvature.

10. The monolithic element of claim 1, wherein the capacitive coupling structures comprise substantially planar surfaces oriented parallel to one another on the adjacent pairs of impedance matching elements.

11. The monolithic element of claim 1, further comprising:
a dielectric spacer disposed on a top portion of the monolithic element, extending between the adjacent pairs of impedance matching elements; and/or
wherein the dielectric spacer is mechanically attached or adhered to the monolithic element, and configured for manipulation of the monolithic element by an automated placement system.

12. A broadband array, comprising:
a circuit board; and
a plurality of intra-element monoliths disposed on the circuit board, each having a base and a plurality of impedance matching elements defining tapered slot edges extending along a tapered section coupled to a leg section, spaced laterally from the base;
a plurality of radiator, receiver or transmitter sites defined between opposing tapered slot edges of adjacent instances of the intra-element monoliths;
a plurality of signal connectors on the circuit board, coupled to the leg sections of first adjacent pairs of the impedance matching elements on each intra-element monolith, wherein the first pairs of impedance matching elements are operable to be actively driven; and
a plurality of grounded connectors on the circuit board, coupled to the leg sections of second adjacent pairs of the impedance matching elements on each intra-element monolith, wherein the second pairs of impedance matching elements are operable to be excited by the opposing tapered slot edges.

13. The broadband array of claim 12, further comprising a plurality of shorting posts coupling each of the impedance matching elements to the base of the respective intra-element monolith.

14. The broad band array of claim 13, wherein:
each base comprises one or more pins configured to maintain spacing and/or rotational alignment between the adjacent instances of the intra-element monoliths; or
the shorting posts each have a first section extending from an inner portion of the respective impedance matching element and a second section extending in a transverse direction from the first section to the base of the respective intra-element monolith.

15. The broadband array of claim 12, wherein:
the bases are asymmetrically disposed between the respective leg sections, or offset with respect to a central axis of the respective intra-element monolith; or
wherein each intra-element monolith comprises four of said impedance matching elements, disposed symmetrically or with bi-lateral symmetry about a central axis of said intra-element monolith.

16. The broadband array of claim 12, further comprising:
a foot defined on each of the leg sections of the intra-element monoliths, where in the feet are configured to couple the respective intra-element monoliths to the circuit board and to connect the first and second adjacent pairs of the tapered slot edges to the signal connectors and grounded connectors, respectively; and/or
a capacitive structure or reinforcement defined on each of the leg sections of the intra-element monoliths, between the respective foot and a tapered or flared section of the respective impedance matching element.

17. The broadband array of claim 12, further comprising a dielectric spacer or cap disposed on a top portion of one or more of the intra-element monoliths, wherein the dielectric spacer or cap is configured to maintain spacing between the impedance matching elements.

18. A method, comprising:
providing a circuit board;
disposing a plurality of monoliths on the circuit board, each comprising a base and a plurality of impedance matching elements extending therefrom, each impedance matching element comprising a tapered section extending from a leg section spaced from the base;
defining a plurality of radiator, receiver or transmitter sites between opposing impedance matching elements on adjacent instances of said monoliths;
coupling the leg sections of first adjacent pairs of the impedance matching elements on each monolith to a plurality of signal connectors on the circuit board, wherein the first adjacent pairs of impedance matching elements are operable to be actively driven; and
coupling the leg sections of second adjacent pairs of the impedance matching elements on each monolith to a plurality of grounded connectors on the circuit board, wherein the second adjacent pairs of impedance matching elements are operable to be excited by the opposing impedance matching elements.

19. The method of claim 18, further comprising:
coupling to a dielectric spacer disposed on a top portion of one of the monoliths, wherein the dielectric spacer is configured for maintaining a selected spacing between the respective impedance matching elements; and
placing said monolith on the circuit board, using the dielectric spacer; and/or
locating said monolith on the circuit board by inserting a pin into a hole or aperture in the circuit board, wherein the pin is configured to maintain rotational alignment or spacing of the monolith with respect to the adjacent instances of said monolith.

20. The method of claim 18, wherein:
disposing the plurality of monoliths on the circuit board comprises inserting a pin extending from each of the leg sections into a top surface of the circuit board, or through the top surface to a bottom surface of the circuit board, opposite the top surface; and/or
further comprising positioning the base of one or more of the monoliths on the circuit board, wherein the base is offset from a central axis of said monolith, or asymmetrically disposed with respect to a center of geometry of the respective leg sections.
